(19) United States
(12) Patent Application Publication
(10) Pub. No.: US 2009/0070103 A1
(43) Pub. Date: Mar. 12, 2009

(54) Management and Processing of Information

(75) Inventors: Marlene Beggelman, Cambridge, MA (US); Yuri Smychkovich, North Andover, MA (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: Enhanced Medical Decisions, Inc., Cambridge, MA (US)

(21) Appl. No.: 12/205,614

(22) Filed: Sep. 5, 2008

Related U.S. Application Data
(60) Provisional application No. 60/970,635, filed on Sep. 7, 2007.

(51) Int. Cl. G06F 17/27

(52) U.S. Cl. 704/9; 704/E15.018

(57) ABSTRACT

Disclosed is a method to perform natural language (NL) processing. The method includes accessing a data source having one or more data portions, and applying multi-stage NL processing on the one or more data portions, using a dynamically generated set of concepts relating to one or more subject matters and relationships between at least some of the concepts, to determine the association of the one or more data portions with one or more of the concepts.

### CROSS-REFERENCE TO RELATED APPLICATIONS

This application claims priority to provisional U.S. application Ser. No. 60/970,635, entitled “Management and Processing of Health Care Information,” filed Sep. 7, 2007, the content of which is hereby incorporated by reference in its entirety.

### BACKGROUND

Natural language processing (NLP) is applied to data sources to process human language for meaning (semantics) and structure (syntax). It further differentiates meaning of words/phrases and larger text units based on the surrounding semantic context (pragmatics). Syntactical processors assign or “parse” units of text to grammatical categories or “part-of-speech” (noun, verb, preposition, etc.). Semantic processors assign units of text to lexicon classes to standardize the representation of meaning. Text communications are said to be “tokenized” when discrete units of text are classified according to their semantic and syntactical categories.

### SUMMARY

Strategies that can be applied to NLP include domain-specific strategies as well as strategies for more general application. Generally, NLP tends to be more accurate within domains that employ highly structured language.

Disclosed is a natural language processing (NLP) and knowledge representation (KR) approach that differs from other existing methodologies in a number of important regards. The disclosed natural language processor's main function is to recognize the presence of predefined concepts and more complex knowledge/information that references these concepts in the corpus of free and structured data source within any subject matter domain (e.g., the medical domain).

The disclosed NLP and KR processing engines, referred to as Knowledge Extraction and Encoding Processors (KEEP), are part of a knowledge-based system that automatically detects and translates predefined knowledge/information in the corpus of both free-text and coded data in any domain. The encoded, translated information is used to auto-populate knowledge bases in decision-support tools, to identify, for example, clinical events of interest in electronic medical records, to improve search results for medical concepts of interest, and to translate complex medical concepts into consumer-friendly language.

With the growing body of medical information available electronically on all subjects, there is a need for an accurate way to find, codify and manage such information. In particular, as an example, with the ever-expanding body of medical information available in both professional literature and in electronically maintained medical records (EMRs), an accurate and efficient way to find, codify and manage medical information is required to optimize exchange of information and the quality of clinical performance. The KEEP system described herein accomplishes this by applying a set of application-specific logical rules to virtually any data source within the corpus of medical literature (free-text, structured data elements, EMR content and coded data). Data captured by KEEP can be mapped to data standards including the Unified Medical Language System (UMLS) and the Health Level Seven CDA data standard (HL7). The KEEP system may be applied to data pertaining to other subject matter domains, including, for example, industry domain, business domain, entertainment domain, consumer domain, etc.

The KEEP system is a generalizable knowledge-base system that automates knowledge-base creation that operates by detecting concepts pertaining to various subject matter domains. Among other things, the KEEP system is configured to detect clinical concepts and events within medical documents. The disclosed KEEP system is configured to process data pertaining to a wide variety of concerns in the areas of, for example, health service and research as well as clinical operations including care quality, outcomes research, creation and maintenance of decision-support products, and enhanced medical search engine capabilities. The KEEP is also configured to perform such processing with respect to other subject matter domains (e.g., business domains, consumers domains, etc.).

Also described herein is the automatic attachment of pre-specified modifiers to automate the generation of ontology branches. Customized ontology generation enables commercially valuable capabilities to easily manage large quantities of information in information-rich domains. Maintaining a manageable ontology that end-users find easily navigable add significant value to informational and decision-support products. By customizing ontology development through “on-the-fly” modifier attachment that is based on the contents within a specified data source, ontology branches can be pruned or expanded so that the ontology's size is controlled and is relevant to the task at hand. Use of a dynamically adjustable (dynamically generated) ontology creates a much more user-friendly experience for the end-user for a great number of product applications derived from use of the source text, including products that assist with information look-up and with decision-support.

Ontology branches for different diagnostic categories might specify only the characteristics (e.g., body areas/location, severity, time course, relation to exacerbating factors, etc) which are relevant to each sub-category and exclude modifiers that are not relevant. In this manner, ontology branches customized for each sub-category with appropriate modifiers are created automatically rather than maintained as hard-coded branches, as they are in other ontology systems. This “on-the-fly”, automated knowledge-driven branch creation (which includes editing, modifying, and adding and deleting of branches, for example) allows for an efficient, practical, and therefore feasible method of ontology creation, and more importantly, for ontology maintenance as knowledge continues to change. In addition, because sub-branches of the ontology differ based on the relevant modifiers that are included, and because irrelevant branches are effectively pruned, the ontologies are streamlined enough to be useful as a menu of choices that can be offered to the end-user as he/she attempts to describe his/her particular clinical profile. More exhaustive ontologies (exhaustive in that they include less finely pruned branches) are typically overwhelming to the end-user in that they contain too many choices and yet often exclude relevant choices (particularly for unusual or uncommon clinical circumstances or for situations that have not yet been incorporated through the maintenance process). For example, assume that a particular diagnosis presents with one set of symptoms acutely and another set during the chronic phase, and that differing body locations are affected with different levels of severity/intensity during acute and chronic phases. To establish diagnostic likelihood, a menu that incorporates (within a branch-tree structure) through which the end-user can maneuver to select the appropriate choices will be much more manageable if each section of the tree contains not only the basic symptom/finding, but sub-categories of the basic finding that more finely describe the exact character of the finding (e.g., constant pain that is localized to the left side of the head near the temple that worsens with lying down). The ability to maintain this level of detail/specificity throughout within an ontology branch is unique to the KEEP system and based on the system's capability to recognize and accurately attach multiple and multi-leveled pieces of information (as well the exact type/nature of the relationship) to basic concepts. Other systems maintain structures that allow for one-concept/one relationship whereas the keep structure maintains multiple/all relevant relationships within a single branch.

In one aspect, a method to perform natural language (NL) processing is disclosed. The method includes accessing a data source having one or more data portions, and applying multi-stage NL processing on the one or more data portions, using a dynamically generated set of concepts relating to one or more subject matters and relationships between at least some of the concepts, to determine the association of the one or more data portions with one or more of the concepts.

Embodiments of the method may include one or more of the following features.

Applying the multi-stage NL processing may include applying at least one stage of the multi-stage NL processing on intermediary one or more data portions resulting from processing performed by another stage of the multi-stage NL processing on the one or more data portions or a processed derivative of the one or more data portions.

The set of the concepts and the relationships between the at least some of the concepts may include an ontology organizing the concepts and the relationships.

The method may further include modifying the dynamically generated set of the concepts and the relationships between the at least some of the concepts based on the processed one or more data portions. Modifying the dynamically generated set may include one or more of, for example, adding at least one additional concept to the set, deleting at least one concept from the set, adding at least one additional relationship to the set and/or deleting at least one relationship from the set.

The set of the concepts and the relationships between the at least some of the concepts may include at least one complex concept associating two or more of the concepts.

Applying the multi-stage NL processing on the one or more data portions may include applying at least one placement rule defining a contextual constraint on the one or more data portions to determine whether two or more terms in the one or more data portions are semantically related. Applying the at least one placement rule may include determining the whether the two or more terms in the one or more data portions are eligible for additional NL processing based on one or more of: semantic content of the one or more data portions, morphological content of the one or more data portions and syntactical content of the one or more data portions. Applying at least one placement rule may include applying a cascade of placement rules defining contextual constraints on the one or more data portions such that one of the cascade of rules is applied to the output resulting from a preceding one of the cascade of rules.

The dynamically generated set of concepts relating to the one or more subject matters and relationships between the at least some of the concepts may include a dynamically generated set of concepts relating to one or more subject matters of: medical applications, industrial applications, business applications, consumer applications and entertainment applications.

The method may further include adding information related to the identified one or more data portions to database records in a knowledge-based system, the database records corresponding to the identified one or more data portions. The information related to the identified one or more data portions may include one or more of, for example, the identified one or more data portions and/or attributes of the respective identified at least some of the one or more data portions. The concepts may relate to medical concepts and a model may be used to treat semantic and syntactic constraints within highly detailed rules as if they are interdependent rather than independent. The concepts may include one or more of, for example, one or more medical drug names, one or more medical conditions, one or more medical symptoms and/or one or more treatments.

The method may further include receiving a search string, determining a resultant search string based on performing another natural language processing operation on the received search string, and searching the database records based on the resultant search string. The search string may include information relating to one or more of, for example, one or more medical drugs taken by a patient and/or one or more medical symptoms experienced by the patient.

Searching the database records may include determining, based on the information in the database records, relationships between the one or more medical drugs taken by the patient and the one or more medical symptoms experienced by the patient. The relationships between the one or more medical drugs taken by the patient and the one or more medical symptoms experienced by the patient may include information representative of whether the one or more medical drugs taken by the patient causes the one or more medical symptoms experienced by the patient.

The method may further include presenting on a user interface output including the determined relationships between the one or more medical drugs taken by the patient and the one or more medical symptoms experienced by the patient.

Applying the multi-stage NL processing may include performing language normalization to identify words within the one or more data portions matching entries of a pre-defined lexicon. Performing language normalization may include performing one or more of, for example, sentence boundary parsing, word segmentation, lemmatization, stemming and identification of lexical variants including synonyms, acronyms, abbreviations, inflectional variants and/or derivational variants.

Applying the multi-stage NL processing may include identifying for at least one part of the one or more data portions related concepts from the one or more concepts. Identifying related concepts may include performing concept identification for at least one of the one or more data portions on which language normalization was performed to identify words within the one or more data portions matching entries of a pre-defined lexicon. Identifying related concepts may include applying to the one or more data portions rules specifying semantic constraints and forward-chaining logic rules.

The data portion rules may be based on Syntactical Rule Model (SRM) rules having a pre-defined part-of-speech/concept configuration.

Applying the multi-stage NL processing may include determining if two or more of the one or more data portions are semantically linked.

Applying the multi-stage NL processing may be performed without performing statistical computations to determine semantic content.

Applying the multi-stage NL processing may include applying disambiguation rules.

In another aspect, a computer program product residing on a computer readable medium for natural language (NL) processing is disclosed. The computer program product includes instructions to cause a computer to access a data source having one or more data portions, and apply multi-stage NL processing on the one or more data portions, using a dynamically generated set of concepts relating to one or more subject matters and relationships between at least some of the concepts, to determine the association of the one or more data portions with one or more of the concepts.

Embodiments of the computer program product may include any of the one or more features described herein in relation to the method.

In a further aspect, an apparatus is disclosed. The apparatus includes a computer system including a processor and memory, and a computer readable medium storing instructions for natural language (NL) processing. The instructions include instructions to cause the computer system to access a data source having one or more data portions, and apply multi-stage NL processing on the one or more data portions, using a dynamically generated set of concepts relating to one or more subject matters and relationships between at least some of the concepts, to determine the association of the one or more data portions with one or more of the concepts.

Embodiments of the apparatus may include any of the one or more features described herein in relation to the method and the computer program product.

In yet another aspect, a method for searching data is disclosed. The method includes receiving a search string, applying multi-stage NL processing on the search string, using a dynamically generated set of concepts relating to one or more subject matters and relationships between at least some of the concepts, to generate a resultant search string determined based on the association of the search string with one or more of the concepts. The method further includes searching records of a database based on the resultant search string.

Embodiments of the method may include any of the one or more features described herein in relation to the first method described above, the computer program product and the apparatus, as well as any of the following features.

Searching the records of the database may include searching the records of a database populated with data generated by applying multi-stage NL processing on one or more data portions accessed from a data source, using the dynamically generated set of the concepts relating to the one or more subject matters and the relationships between at least some of the concepts, to determine the association of the one or more data portions with one or more of the concepts.

The method may further include modifying the dynamically generated set of the concepts and the relationships between the at least some of the concepts based on one or more of, for example, the processed one or more data portions and/or the search string.

The search string may include information relating to one or more of, for example, one or more medical drugs taken by a patient and/or one or more medical symptoms experienced by the patient. Searching the database records may include determining, based on the information in the database records, relationships between the one or more medical drugs taken by the patient and the one or more medical symptoms experienced by the patient.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary embodiment of the organization of the layers of the NLP engine.

FIG. 2 is a block diagram of an exemplary embodiment of a generic computing system on which the system can execute.

FIG. 3 is a flowchart of an exemplary multi-stage (multi-level) natural language (NL) processing procedure.

FIG. 4 is a flowchart of an exemplary simple concept identification procedure constituting part of the multi-stage NL processing procedure of FIG. 3.

FIG. 5 is a flowchart of an exemplary dynamic ontology customizing procedure.

FIG. 6A is a flowchart of an exemplary knowledge-based searching procedure.

FIG. 6B is an exemplary output generated in response to a query provided by a user searching a medical knowledge-based system.

FIGS. 7A-7RR are screenshots of exemplary embodiments of graphical-user-interfaces for decision support applications.

### DETAILED DESCRIPTION

Disclosed are methods, apparatus and computer program products to perform natural language (NL) processing. In some embodiments, NL processing may include accessing a data source having one or more data portions, and applying multi-stage NL processing on the one or more data portions, using a dynamically generated set of concepts relating to one or more subject matters and relationships between at least some of the concepts, to determine the association of the one or more data portions with one or more of the concepts.

Also disclosed are methods, apparatus and computer program products to search data. Searching data may include receiving a search string, applying multi-stage NL processing on the search string, using a dynamically generated set of concepts relating to one or more subject matters and relationships between at least some of the concepts, to generate a resultant search string determined based on the association of the search string with one or more of the concepts, and searching records of a database based on the resultant search string. In some embodiments, the search string includes information relating to, for example, one or more medical drugs taken by a patient and/or one or more medical symptoms experienced by the patient. Under those circumstances, searching the database records may include determining, based on the information in the database records, relationships between the one or more medical drugs taken by the patient and the one or more medical symptoms experienced by the patient.

The Knowledge Extraction and Encoding Processors (KEEP) system described herein uses four distinct informatics technologies: (1) a complex ontology (i.e., a set of concepts relating to one or more subject matters and the relationships between at least some of the concepts) of contextualized concepts in which the ontology represents concepts as existing in context (as knowledge) in addition to representing them as basic/atomic units that can be further contextualized to fine-tune categorization or the assignment of meaning; (2) a hybridized semantic/syntactic rules-based processor that analyzes the meaning and structural properties of sentences/phrases as dependant rather than independent variables thus resulting in an implementation that more precisely simulates human language processing which has been developed as a customized application program interface (API) for content development without programming experience; (3) a robust domain-specific Knowledge Representation (KR) model linked to translation templates that have placeholders in which specific instances of classes of data can be populated as they are identified within source text; and (4) a system to dynamically customized (or generates) ontology.

Many conventional systems map clinical text to concepts within standardized knowledge bases such as the Unified Medical Language System (UMLS) and may or may not apply other levels of contextual processing to disambiguate concept assignment. Some conventional systems, such as MediClass™, map normalized tokens processed from the medical text to normalized string forms of UMLS concepts. The MediClass and MetaMap systems use a “goodness score” to estimate the accuracy of UMLS concept mapping. This score weighs the relative contributions from tokenized items recognized in the parsed source text.

Some systems use statistics-based classifiers instead of contextual processors to fine-tune concept classification. These classifiers typically rely on rules-based or probabilistic statistical analyses. Limited research suggests that under some circumstances statistically-based modeling is not as accurate as rule-based processing.

NLP systems typically have applied syntactical and semantic processing sequentially. For example, one well-studied system tags words and assigns them to a grammatical category. Individual words are then combined to form higher level syntactical categories (noun phrases, prepositional phrases, etc). The words and phrases are classified into semantic groups using a Bayesian approach.

The MediClass system uses a semantic classification and a version of a publicly available statistical analysis to transform clinical encounter notes into a collection of instantiated medical concepts represented by a standardized medical ontology (UMLS Metathesaurus). Concept matches are scored for “goodness” according to the number of derivations and deletions that are applied to the original text segment to provide the match, and the amount of separation in the original text among word token variants involved in the match. Variants and their scores are produced by the “Generate Fruitful Variants” configuration of the Lexical Variant generation (LVG) tool of the UMLS.

The KEEP system described herein provides automated coding and classification of free-text from diverse sources of information, including, but not limited to medical information, as well as from digitized clinical records. The system automatically identifies clinical information of interest to professional and non-professional end-users, generally by auto-populating information into decision-support knowledge bases.

While the operations of the systems and methods described herein are described using illustrative examples relating to a medical knowledge-based system configured to process medical-based information, it will be appreciated that the systems and methods described herein may equally be applied to any other subject matter, including, for example, subject matters pertaining to industry information (e.g., mineral mining, automotive industry), business applications (e.g., stock and securities information), entertainment information, consumers' information, etc.

In some embodiments, the KEEP system is configured to perform accurate processing of medical data for knowledge representation classification and translation. Particularly, the KEEP system implements an approach to work with any source of information, including, for example, medical literature and digitized clinical records, that would accurately classify, encode, and translate knowledge expressed within the text. The implementation of the KEEP system described herein achieves a higher level of accuracy than has previously been achieved, a high level of scalability and processing efficiency, easy maintainability through an application interface that allows direct system access to domain experts and decreases reliance on programming, development of a consumer-oriented ontology of clinical terms with the ability to map to formal standard nomenclature systems, and closer simulation of human language processing methods.

The KEEP system processes large volume of information to auto-populate decision-support knowledge bases of the system at a high accuracy rates, scalability and efficiency. For example, in some embodiments, the KEEP system may be required to process million of records (for example, to auto-populate a knowledge base pertaining to a drug-related decision-support product, described below). Under these circumstances, if the KEEP system is to have anything less than a 95-97% sensitivity and specificity, too many data points would have to be processed manually. This level of accuracy (i.e., 95-97% sensitivity and specificity levels) is higher than what is achieved by comparable NLP systems.

To achieve the above-identified level of accuracy, the KEEP system described herein is configured to closely approximate human language processing methods.

Particularly, to obtain an accurate classification of data records, the implementation of the KEEP system is based on a multi-staged system of analysis that more finely and accurately models the relationships between independent and dependant segments of tokenized text. Other systems often rely on statistical short-cuts that allow for more expedience system development, but that are not able to achieve high levels of accuracy for disambiguation, for determining which tokens are related, and/or for determining the nature of the relationships. The lack of accuracy is particularly problematic (and multiplicative) when text contains multiple independent and dependent tokens and when multiple relationships exist between tokens. Conventional NLP systems that do not use statically modeling tend to rely heavily on parsing or part-of-speech analysis which is generally a crude indicator used to establish which tokens are related and the nature of the relationships. In contrast, the KEEP system described herein uses a multi-layered and highly structured analytic processes to determine the relationships between the individual words (e.g., identifies which words are semantically related) to identify “simple concepts”, then establishes the relationships between “simple concepts” and defines these as “complex concepts”. Additionally, the KEEP system tracks multiple relationships between all concepts (simple/simple; simple/complex; complex/complex) and structures these relationships within highly customized and detailed ontology branches. In addition, the KEEP system may sub-categorize inflection, part-of-speech, and may further specify allowable subcategories based on specific syntax structures. The high level of accuracy achieved by the system is made possible by the highly detailed, step-wise and specific processes used by the system to tokenize the text and to identify relationships between the concepts.

Additionally, the KEEP system uses a Syntactical Rule Model to achieve classification accuracy. Specifically, the KEEP system uses a set of abstract syntax-based constructs upon which forward-chaining logical procedures that define concepts can be modeled. The set of constructs, called the “Syntactical Rules Model” (SRM), specifies a large number of possible semantic configurations involving part-of-speech (POS), POS order, and concept/POS order. Once the appropriate subset of syntactical constructs have been selected for a rule, a subset of allowable semantic expressions are customized for each placeholder in the rule, based on the particular syntax construct and on the particular concept that is being invoked.

For example, two commonly used instances of the SRM construct set are:

MOD, NOUN, VERB . . . CONCEPT . . . [VERB GP]; and

NOUN, PREP, MOD, VERB . . . CONCEPT . . . [VERB GP].

For a specific concept, a subgroup of allowable words/word forms, inflections, POS, etc., would be customized to the placeholders within the SRM construct. For example, only certain subcategories of prepositional phrases (rather than any preposition) would typically be allowed in the example above. Specific verbs that are allowed might be further limited to a subgroup of inflections of those verbs, and would typically differ for the two constructs shown above.

In contrast, the approaches followed by other NLP engines use, generally, part-of-speech and inflection independent of syntax and semantic values of the tokens within the text rather than identifying subsets of inflection part of speech customize to the semantic/syntax context. It is also a common practice for conventional NLP engines to address inaccuracies through an overlay of high-level statistical constraints applied at a rules level. Examples of such constraints include token proximity, nearest neighbor, probabilistic/Bayesian, and “goodness of fit” measures. However, some studies have suggested that the use of statistical constraints is not as accurate as contextual processing that uses explicit domain-specific expert knowledge. Thus, the implementation of the KEEP system described herein does not incorporate statistical methods.

The KEEP system is further configured to auto-populate consumer-oriented medical decision-support systems. Particularly, in some embodiments, a decision-support system to identify medication-related problems (e.g., whether a combination of drugs taken by a patient caused or is related to onset of particular medical symptoms) is implemented. The system needs to easily accommodate additional knowledge representation models for other domain types (e.g., diagnostic and treatment knowledge representation models). Other types of medical decision-support system that address other types of medical problems may also be implemented. Thus, the KEEP system leverages existing knowledge sources and also accommodates additional knowledge specification (e.g., knowledge acquired from textbooks or other published sources of medical information). The KEEP system is also configured to make explicit the links between the raw data source, knowledge formally encoded into the system, and the classification results produced by the system.

The KEEP system is additionally configured to identify medical concepts in both free-text and coded data. Particularly, the system is able to map the contents of coded and uncoded data into a common set of abstract medical concepts or a knowledge representation so that the entire text could be subjected to a uniform analysis.

Recognizing coded data allows the system to map to standardized nomenclature systems such as UMLS and HL7.

The KEEP system is further configured to recognize both common language and formal medical terminology. Generally, standardized nomenclatures have not been established for common language expressions for medical concepts. Thus, to use consumer-facing decision-support system, common language expressions within text have to be identified, particularly within consumer queries. The system is thus capable of linking common language queries to concepts and knowledge representations that use formal medical language.

The KEEP system is also configured to structure concepts into an ontology that specifies the relationship between classes. Particularly, to point the end-user (e.g., patients, physicians) to a robust selection of information that may be relevant to their query, the concepts have to be organized into an ontology that makes explicit the relationships between individual/groups of concepts. Multiple relationships may be expressed within one ontology branch. Particular relationships that are specified include the level of detail expressed in either end-user input or in the knowledge source that is being processed, as well as specific relationships between individual classes and, additionally, relationships between concepts included within an ontology branch when multiple concepts are present. As will be described below, the system required several different functions to express different types and levels of relationships.

The KEEP system is further configured to achieve a high processing throughput. Specifically, the KEEP system processes large volumes of data in a highly efficient and accurate manner. In some implementations, the KEEP system enables real time recalculation of the entire database as knowledge concepts are added or edited, without deterioration in system performance. Meeting these performance metrics is enabled by optimizing the efficiency of the procedures implemented by the system, and by minimizing unnecessary data points in within the knowledge representation model. The latter is accomplished through a content architecture that “clusters” or “bundles” concepts into increasingly complex knowledge representation units. The more the concepts are combined or bundled, the fewer separate data points, or nodes, that are in the model. In other words, the knowledge representation model eliminates extraneous information and limits knowledge representation to the minimum number of important concept combinations, as well as optimizing the efficiency of the procedures implemented by the system.

The KEEP system's high-level architecture includes several modules. Particularly, the KEEP system includes a Natural Language Processing (NLP) engine implemented, in some embodiments, with four separate layers.

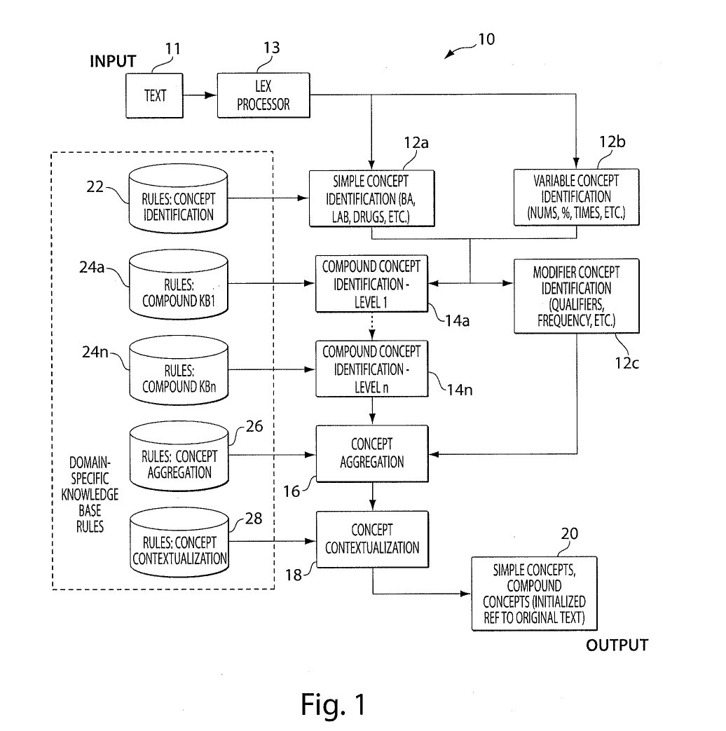

Referring to FIG. 1, a block diagram of an exemplary multi-stage (multi-layer) NLP engine 10 is shown. The engine 10 includes, in some embodiments, a simple concept identification layer 12. This layer identifies the abstract medical concepts, represented in the Concept Ontology, that are contained in free-text portions of medical text. The abstract medical concepts are drawn from the Concept Ontology in which medical concepts are classified to specific classes of interest. Concept identification is performed using a series of NLP procedures, as described in greater detail below. Concepts are said to be fully “instantiated” when additional context captured by concept modifier logic is attached to the concept.

Another layer of the NLP engine is the Compound Concepts/Knowledge Classification layer (also referred to as the Complex Concept layer) 14. This layer implements classification of source text against Knowledge Representation categories using a rules-based classification engine. Instantiated concepts produced during the first stage of analysis, along with other tokens within the sentence(s), are run against the rules to determine for which rules constraints are met. For each domain of interest, a comprehensive set of knowledge classes is defined that would be of interest to the target end-user(s). As shown in FIG. 1, the Compound Concepts/Knowledge Classification layer comprises several sub-layers 14ₐ-14ₙ, each of which corresponding to a higher level of complexity in that higher levels incorporate increasingly more contextual information from the source text, a larger number of concepts and, typically, more constraints within its associated rules. Lower level rules are often a subset of higher level rules.

A further layer of the NLP engine is the Concept Aggregation layer 16. Concept modifiers are evaluated by domain-specific sets of forward-chaining logical rules for each concept identified within the data source segment. Modifiers include severity, frequency, quantity, timing, quality, etc. Modifiers are “attached” or linked to corresponding concepts.

Yet another layer of the NLP engine is the Concept Contextualization layer 18. This layer evaluates the context within which each concept exists and applies a set of hierarchical rules to reconcile overlapping, redundant, or contradictory rules.

The NLP engine also includes the functionality for translating the semantic contents represented by each node on the Knowledge Representation tree. This layer translates abstract classes of medical knowledge (or knowledge from any other subject matter domain) identified within source text from formal medical language into common language. Each rule linked to a Knowledge Class within the Knowledge Representation tree maps to a standardized template with placeholders into which specific instantiated concepts can be populated. Knowledge can be translated into common English or into other languages.

With more particularity regarding the operations performed by the engine (apparatus) 10, the functions performed by the various layers are based, in some embodiments, on rules defined in associated rule sets (stored, for example, in one or more storage devices coupled to the engine 10). Thus, for example, at least some of the operations performed by the Simple Concept Identification are based, at least in part, on rules defined in the rule set 22.

The NLP engine 10 receives source data 11 from, for example, on-line sources available on private or public computer networks. The text data 11 thus received is initially processed by a lexicon processor 13 that performs language normalization on the received data. Such language normalization processing may include tagging recognizable words in the received data source (as will be described in greater detail below) that may pertain to the general subject matter with respect to which the knowledge-based system is being implemented.

The source data, which may have been intermediary processed by the Lex processor 13, is then processed by the concept identification stages of the engine 10, which include simple and complex concept identification stages.

Referring to Table 1 below, a summary of the configuration of the Concept Identification layer (stage) is provided.

TABLE 1
Concept Identification

Basic Functions: Sentence Boundary Parsing; Word Segmentation;
Lemmatization; Stemming; Identification of Lexical Variants (synonyms,
acronyms, abbreviations, inflectional variants, derivational variants)
Apply rule-level constraints/forward-chaining logic rules
(SMARTSEARCH RULES)
Optional and required word forms/lexical items; abstract concepts/
lexemes
Required expressions (one or more) from within a sub-group of
“semantically equivalent” expressions
Optional and required token order Exclusions (global, rule-specific,
negations, idioms, etc)
Delimiter Identification
Exclude Parent Matches
Apply Fixed Expressions/Multi-word Expression Matching (EXACT
TERMS)
Handle Idioms, Colloquial expressions, Collocations, Word-/Phrasal-
compounds
Apply High-Level Syntax Rules (PLACEMENT RULES)-to address word
segmentation ambiguity
Concept Classification
Associated Knowledge Matching-forward-chaining logic rules (CONCEPT
CONTEXTUALIZATION)
“Close” associations
“Distant” associations
Modifier Matching (frequency-quantitative/qualitative measures; severity;
timing; changes over time; strength of evidence; exacerbating
factors; etc.)

As noted, the Simple Concept Identification layer 12 of the NLP engine 10 is configured to identify basic units of semantic content within source text. This layer's primary function is to transform free-text into structured, abstract concepts within the concept ontology. The general form of this knowledge representation is a collection of many different instantiated concepts (e.g., medical concepts) drawn from a common language, as well as medical language ontology. The ontology is a set of possible abstract concepts and relationships among those concepts. Each abstract concept in the ontology may be associated with a unique concept identifier which links together synonymous terms/phrases, including formal and common language terms. In some embodiments, for applications to process medical records as described herein, a typical repository of synonyms may include in excess of 100,000 discrete terms of synonyms.

The transformation of raw data into knowledge representation in this layer of the architecture entails identification of the ontology concepts represented by the terms contained in segments of input data portions containing natural language text. Thus, the system (shown in FIG. 1) performs free-text processing (as described in greater detail below) on all segments of data contained within the data source in, for example, a four-stage process. First, the entire text is parsed by the lexical processor 13 for sentence boundaries and other patterns of interest (word segmentation, lemmatization, stemming, delimiter identification). In the next series of processes, separate stacks of increasingly complex Rule Knowledge Bases sequentially process bounded text in the following manner. In the second step, which follows the establishment of boundaries and semantically related tokens, each token identified in the text is subjected to processing involving tokenization and word variant generation (including synonyms, acronyms, abbreviations, inflectional variations, and spelling variations). Third, each set of tokens within a sentence (or under certain circumstances, sentences) is subjected to a high-level syntactical processor (HSP) that uses a set of domain-specific procedures that specify the tokens within a segment that are semantically linked and, therefore, can be processed as a group by the set of rules (e.g., placement rules). This stage also addresses word segmentation ambiguity issues. Fourth, candidate token groups are evaluated against forward-chaining logical rule-sets that are linked to ontology classes to determine the classes which are invoked in the text. Rule-level constraints determine which individual concepts/tokens apply to the rule. Abstract concepts or word forms may be optional, required, excluded, or have a required order. One or more word forms from within a group of lexical items may be required. Exclusions may be specified at a global, rule-specific level, and they may also include negations, idioms, etc. Delimiter identification is specified at the rule-level as well. Fifth, fixed expressions/multi-word expressions are identified by string matching. These “Exact Term” matches are linked to ontology classes. Concepts are “triggered” or “fire” when the constraints of one or more of the rules that define that concept are met. More specifically, if the constraints of one or more of the forward-chaining logical rule (referred to as SmartSearch Rules) associated with a concept are met, or one or more EXACT TERMS “fire”, then the concept is said to be “classified”. The text segments are tested against alternative rules-sets from closely related knowledge representation constructs that are easy to confuse with the concept of interest (because of over-lapping rules constraints or matches). If one or more of the rules associated with associated knowledge representation constructs from a higher level, then the more highly detailed, or “child” level concept, rather than the original concept of interest, “fires”. Additionally, text segments that contain classified concepts are tested against forward-chaining logical rules for associated modifiers. These may include additional information that describe or add semantic content to the concept including frequency, severity, duration, course over time, response to exacerbating/alleviating factors, strength of evidence, etc.

To achieve a higher level of accuracy (specificity and sensitivity) in identifying and codifying semantic content within free-text, an innovative approach to rule construction and processing strategy is used. The approach used to perform the forward-chaining logic rules is predicated on the underlying assumption that allowable semantic forms/expressions are dependant on more finely specified subcategories of semantic forms that are typically used with other NLP engines, and the choice of which is determined by the specific syntactical and semantic construct that is used within a rule. The implemented approach enables customization of semantic content for each rule that is based on a combination of the specific type of knowledge being represented and on the syntactical construct represented within that particular rule, subcategories of parts of speech, inflections, etc.

To implement the forward-chaining logic rules procedure, generalizable syntactical constructs, referred to as “Syntactical Rule Model set” (SRM), can be used as the initial structural basis for rule development. SRMs are abstract frameworks that specify possible POS/CONCEPT order combinations. For each concept, a subset of appropriate SRMs is selected. These abstract frameworks are then populated with specific words/word forms appropriate to the semantic content of the concept and to the SRM structure. It is to be noted that in some embodiments, an SRM may be implemented that provides an application-program-interface (API) that is content-developer-friendly.

Each concept is typically defined by several to many rules. Each rule is an instance based on Syntactical Rule Model (SRM) set. Each rule incorporates a pre-defined, structured, specific POS/concept configuration. Based on the SRM configuration and the semantic representation reflected by the concept, a subset or allowable semantic expressions are customized for each constraint within the rule.

For example, the syntactic construct:

“NOUN/POS
SUBGP16...VERB/INFLECSUBGP4...ModTYPE22OPTIONAL...
PrepSUBGROUP11...CONCEPT /ABSTRACTSUBGP234...
VERB GROUPSEMANEQUIVSUBGP36(INFLECSPECIFIED)”,

may be used within a rule for the Knowledge Representation CLASS “Specific condition as a risk factor for specific drug interaction”. For this particular rule, a certain subgroup of prepositions and verbs are allowable, as are certain inflections of each verb whereas another rule used within this same class may specify a different subgroup of prepositions and may not allow the same inflectional variants.

To facilitate the specification of customized allowable expressions within SRMs, standard lists of words and phrase constructs, whose instances are “semantically equivalent” for the purposes of semantic representation (not synonyms, etc), are used. Semantic equivalent groups may contain abstractions, specific terms, pre-specified inflections/parts-of-speech, as well as concepts that are not synonymous but are semantically close/equivalent. These established, pre-defined semantic groups can often be used without alterations but may require further customization for specific rules which therefore result in a new semantic equivalent grouping.

Lexical processing includes recognizing all variants within a data source portion likely to hold semantic meaning of normalized word forms or exact words within the concept ontology rules. For example, the system takes as input a segment of English natural language text and sequentially attempts to match for the presence of normalized word forms or words within lexical rules, starting with more words forms and proceeding to specific words. Segments that do not contain all required word forms/words are discarded as candidates for that particular rule. Output at this point consists of segments that have not yet been discarded for non-matches, mapped to the rules that they invoke. At the next level syntactical requirements specified by the candidate rules are evaluated against the non-discarded text segments. These syntactical specifications may include word order, part-of-speech, and allowed inflections.

The concept identification procedure includes determining the eligible tokens within a text segment that should be linked semantically. In other words, tokens that are constituents of the same line of thought and should, therefore, be analyzed as a unit against the rules-sets. This processing corresponds to the implementation of high-level syntax rules (to address word association/segmentation ambiguity). For example, in the phrase “he had pain radiating to his neck chest and a full sensation in his abdomen”, pain is associated with the body areas “neck” and “chest”, but not “abdomen”. Identification of these “token groups” is accomplished by a higher level syntactical processor (Placement Rules) based on forward-chaining procedures. Some of these high-level procedures have been customized for specific categories of groups such as “increase/decrease” and body area associations.

As noted, and with reference to the Compound Concept/concept contextualization layer 18 of FIG. 1, once concepts have been identified, they are evaluated against a set of forward-chaining rules that further refine semantic meaning by evaluating concepts contextually (such procedures are referred to as associated knowledge matching). These rule-sets are member of knowledge representation classes that are closely related to and often confused semantically with the concept of interest. For example, the concept identification process might classify tokens within a text as representing “hypertension”. The concept contextualization process applies rules to determine whether the “hypertension” referred to in the text represents a drug side effect, a risk factor for another condition, an unrelated underlying condition, an indication for treatment (rather than an effect of treatment), a requirement for study inclusion, etc. The rules that test for associated knowledge classes are similar in structure and functionality to those used for the original concept identification but different in semantic content and tend to apply to broader text segments. These rules may be developed and defined based on knowledge involving expert opinion and published literature. Once concepts are evaluated in context, they are said to be “instantiated”.

Modifiers (modifying information items) are attached to instantiated simple concepts by applying forward-chaining logic rules to the data source segments in which the concepts are located. Modifying information may include frequency (qualitative or quantitative), severity, time factor, dose/intensity of exposure, associated factors, strength of association, references, information reliability, duration, timing/changes over time, location, cause, associated/accompanying factors, physical characteristics, etc. The type of modifiers that may be used include simple modifiers, complex modifiers, modifiers that attach to simple concepts and modifiers that attach to complex concepts. Simple modifiers attach directly to the primary or independent concepts. Complex modifiers are first identified as independent complex concepts that can be used either as independent concepts or that can be attached as secondary or modifying concepts for other, either simple or complex concepts. Both simple and complex concepts may be attached as modifiers to simple concepts within a complex concept or to the entire complex concept.

Referring to Table 2 below, a summary of the configuration of the domain-specific compound concept (i.e., knowledge), identification layers (comprising several layer 1-n) is provided.

TABLE 2
Knowledge Identification

Basic Functions: Sentence Boundary Parsing; Word Segmentation;
Lemmatization; Stemming; Identification of Lexical Variants (synonyms,
acronyms, abbreviations, inflectional variants, derivational variants)
Concept Identification
Apply rule-level constraints/forward-chaining logic rules
(SMARTSEARCH RULES)
Optional and required word forms/lexical items; abstract concepts/lexemes
Required expressions (one or more) from within a sub-group of
“semantically equivalent” expressions
Optional and required token order
Exclusions (global, rule-specific, negations, idioms, etc)
Delimiter Identification
Exclude Parent Matches
Population of Translation Template

As noted, the basic concept identification layer produces a representation of the text includes many instantiated concepts. In some embodiments, hundreds to thousands of concept instances are produced for an average monograph/section of text. The next layer of analysis, executed through higher levels of Rule Knowledge Bases, determine the semantic context in which these concepts are invoked. The Knowledge Representation processing function resides in a series of rules engines that execute sets of forward-chaining logical rules over text segments containing the set of concept instances categorized during Basic Concept Identification. Each rule is tied to a specific node in a Knowledge Representation ontology. Each node typically has several to many rules. The engine operates by iterating through all rules and is “triggered” or “fires” when rule constraints are met. It is to be noted that four types of constraints may be coded into rules by the rule author, namely, global constraints, concept-level constraints, rule-level constraints, and token-level constraints (this is also true for simple and complex concepts).

As with Basic Concept Identification rules, constraints for Compound Concept Knowledge Identification rules may include required words/word forms, optional words/word forms, excluded words/word forms, required versus optional word order, specified part-of-speech, requirement of one or more words, concepts, or word forms from a group of multiple words, concepts or word forms, tokens that represent starting and stopping points (delimiters) of an analyzable text segment, etc.

Compound concept Knowledge Representation models are organized as branching structures with “child” branches generally including a more specific or detailed version of the information represented in the “parent” branch. For example, a parent branch “blood tests are recommended when combining drugs (specific drugs)” may have as a child “blood test (specific) are recommended when combining drugs (specific drug)”. The parent branch recognizes test in which blood tests are recommended but not specified, whereas the mention of specific blood tests will trigger the child representation. The engine automates the process of recognizing and attaching the child branches with an increased level of specificity for pre-defined variables (such as time course, procedures and tests, diagnosis and conditions, etc). This auto-identification represents one aspect of text-driven automated ontology creation (see below).

Semantic units represented by branches of the compound concept Knowledge Representation models are designed to identify the presence of abstractions in source text and to subsequently identify the specific instance of the abstraction within the source text. In this way, one Knowledge Representation node can efficiently handle hundred to hundreds of thousands of semantically distinct data items. In addition, and as will be described in greater detail below, as branches with increased levels of specificity are automatically identified as they are found within source text and added to the parent branch to create new child branches, the number of child branches in the ontology increases (under some circumstances, it may increase exponentially). Since the parent branch contains a higher level abstraction with more specific branches implicit, the exposed tree does not require full display to be comprehensible.

Each complete semantic unit represented by a node in a Knowledge Representation model has a corresponding “translation template” written in common language text that includes placeholders into which specified instances of word forms contained in the source text can be populated. Placeholder can refer to concepts, numbers, units, frequencies, time, location, ranges, etc. In the blood test example above, specific blood test(s) would be recognized and populated into the appropriate template. Templates may incorporate multiple placeholders, and even more than one placeholder for different instances or subgroups of the same class.

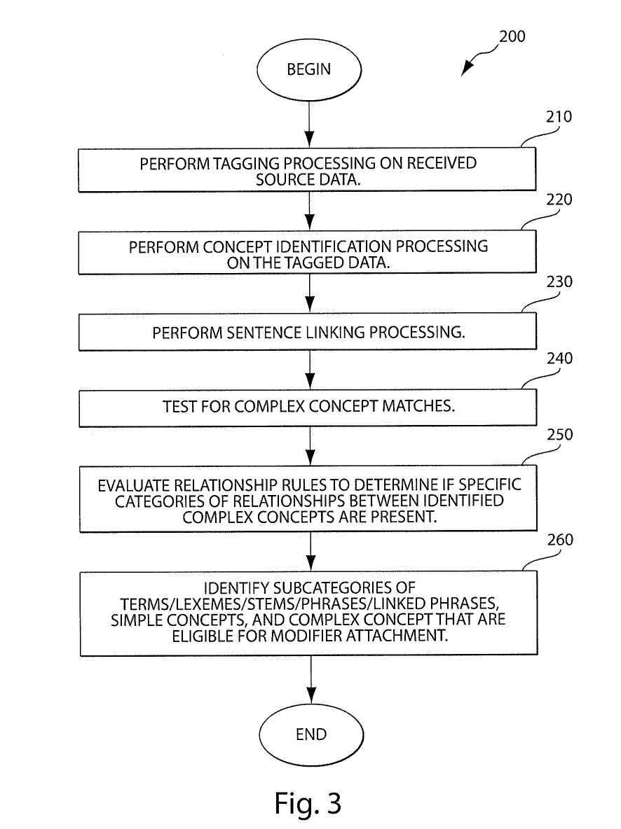

Further details regarding natural language processing performed in the manner described herein (e.g., using, for example, a system such as system 10) are provided below in relation to FIGS. 3-5.

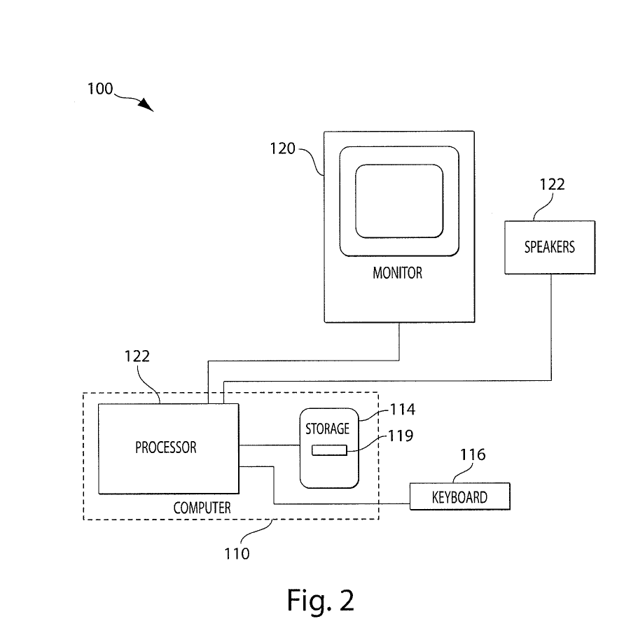

Referring to FIG. 2, an exemplary embodiment of a generic computing system 100 to implement the KEEP system is shown. The computing system 100 is configured to process information accessed on private and public computer network and perform contextual processing, as described herein, to construct knowledge-based system, e.g., knowledge-based system auto-populated with medical information. The computing system 100 includes a computer 110 such as a personal computer, a personal digital assistant, a specialized computing device or a reading machine and so forth.

The computer 110 of the computing system 100 is generally a personal computer or can alternatively be another type of computer and typically includes a central processor unit 112. The computer 110 may include a computer and/or other types of processor-based devices suitable for multiple applications. In addition to the CPU 112, the system includes main memory, cache memory and bus interface circuits (not shown). The computer 110 includes a mass storage element 114, here typically a hard drive. The computer 110 may further include a keyboard 116, a monitor 120 or another type of a display device.

The storage device 114 may include a computer program product that when executed on the computer 110 enables the general operation of the computer 110 and/or performing procedures pertaining, for example, to the construction of knowledge-based databases

In some implementations the computer 110 can include speakers 122, a sound card (not shown), and a pointing device such as a mouse 119, all coupled to various ports of the computing system 110, via appropriate interfaces and software drivers (not shown). The computer 110 includes an operating system, e.g., Unix, Windows XP® Microsoft Corporation operating system. Alternatively, other operating systems could be used.

Although FIG. 2 shows a single computer that is adapted to perform the various procedures and operations described herein, additional processor-based computing devices (e.g., additional servers) may be coupled to computing system 100 to perform at least some of the various functions that computing system 100 is configured to perform. Such additional computing devices may be connected using conventional network arrangements. For example, such additional computing devices may constitute part of a private packet-based network. Other types of network communication protocols may also be used to communicate between such additional devices.

Alternatively, the additional computing devices may be connected to network gateways that enable communication via a public network such as the Internet. Each of such additionally connected devices may, under those circumstances, include security features, such as a firewall, VPN and/or authentication applications, to ensure secured communication. Network communication links may be implemented using wireless or wire-based links. Further, dedicated physical communication links, such as communication trunks may be used.

Referring to FIG. 3, a flowchart of an exemplary multi-stage (multi-level) natural language (NL) processing procedure 200 is shown. As noted above, NL processing of data portions to determine their conceptual meaning is performed by a multi-stage analysis that, in some embodiments, is based on the progressive application of rules to the intermediary processed data portion being analyzed (i.e., the “next” level of analysis is performed on the intermediary result of processing of the data portion by the preceding level of analysis).

As previously explained, tagging of source data in the course of organizing the data (e.g., into ontological structures) in conventional NLP-based systems tends to be too inaccurate for the purpose of developing decision-support tools. Much of the inaccuracy can be explained by the trade-offs inherent in systems that short-cut the NL processing engine development process such as with the use of statistical approximations. Statistical short-cuts, for example, greatly reduce system development time but, on the other hand, impede systems from reaching the level of accuracy needed for programs that process large volumes of information in which the number of errors (which tend to be compounded when combined) quickly overwhelm the ability of the available resource to provided reasonably high quality assurance and error correction. Thus, improved accuracy rates over those achievable with existing conventional NL processing engines/software is achieved using a highly structured, complex, multi-staged and comprehensive approach to processing the data/source material that does not rely on the same types of statistical approximations used by conventional systems. Such a system, which may be similar to the system 10 described herein with reference to FIG. 1, is modeled to emulate key components of processes that may theoretically be used during human language interpretation.

In operation, the procedure 200, performed, for example, on the system 10 of FIG. 1, initially performs a pre-tagging process 210 (e.g., “high sensitivity; low specificity” tagging) on received source data. As explained herein, the source data, which may include, for example, text-based data, marked-language-based data, and other types of data formats, are accessed from various sources. Those sources may include databases available on private networks (e.g., virtual private networks or VPN's), public networks (e.g., the Internet), etc. For specific applications that utilize source data organized in specialized knowledge-based systems (e.g., the DoubleCheckMD Drug application, described in greater detail below, that diagnoses, drug-interaction problems and contraindications), specialized data crawlers (e.g., web crawlers or web spiders) that traverse networks, or other data sources, may be employed to seek source relevant data. For example, network crawlers that search and access servers containing medical based data may be used to automatically seek germane data required for specialized medical applications.

In performing the initial tagging operations, data arranged in sentences (be it data that was originally in text format, marked-up language format, or any other format) are initially tagged with simple terms/phrases that are used to screen for the presence of specific sub-categories of content within a domain. These domains pertain to general subject matters with respect to which data is to be arranged. For example, in the DoubleCheckMD Drug application described in greater details below, the subject matter with respect to which data is processed and arranged in a manner that would enable subsequent knowledge-based data searching, includes therapeutic drug-related data, including side effects associated with various drugs, and interactions between different drugs. The initial level of tagging is meant to dismiss sentences with a low likelihood of relevant content and to include sentences with a moderate to high likelihood. For example, in some embodiments, the types of terms/phrases with respect to which source data is processed (e.g., by comparing the content of the source data to a set of the simple terms/phrases) is such that content that merely contains a literal occurrence of the terms/phrases/key words included in the set against which the data is compared will cause the data source containing such literal occurrence of the terms/phrases to be tagged. This filtering stage may lead to large percentage (e.g., as much as 50%) of the data portions tagged at this level to be false/incorrect tags. Tagged sentences are stored on a storage device, such as the storage device 114 of FIG. 2. The tagged sentences may also be stored in an ordered manner by storing those sentences into sections of the database executing on the computing system 100. The stored tagged sentences are thus made available for the next processing stages.

To facilitate explanation of the procedure 200, an example of a source data, in this case a sentence describing medical side-effect conditions a patient might experience will be used to illustrate the various processing stages/levels performed by the multi-stage processing of the procedure 200. This example sentence may be part of a free text monograph on drug side effects from a company that aggregates/publishes drug information for hospitals:
Example sentence: “Hypovolemia, excessive thirst, and excessive urination can predispose some patients to lightheadedness and syncope.”

Initial tagging operations performed on the above example data portion thus determines whether there is a likelihood that a sentence will contain relevant information for the sub-domain of interest (e.g., instances of the concept “SIDE EFFECT”). In the above example sentence, the recited term “predispose” is identified as a synonym of a particular “side effects” indicator, and accordingly this term is tagged.

Having determined that there is a likelihood that the data portion being processed may pertain to an ontology available on the system, in this case the side-effect ontology, all the words in this data portion that are recognized by the system are tagged (identified words may be members of abstract classes or may be individual terms that are components of the SmartSearch rules within the particular ontology, e.g., the side effect ontology). In this case, most of the words in the above medical side-effect example are recognized, and thus tagged, by the system. It is to be noted that while individual term recognition of words in the data portion is performed, matching of any of the tagged terms or of parts of the data portion to specific ontology rules has not yet, at this processing stage, been performed.

In some embodiments, a procedure to determine when sentences should be combined and analyzed may be used. This procedure may use similarly structured forward-chaining techniques that, if matched by sequential sentences, those sentences may be analyzed as a unit using simple and complex rules. For example, the sentences “Drug A and drug B when combined can cause anorexia. Some experts suspect that they can lead to high lead levels” may be treated as a single unit within the side effect processor.

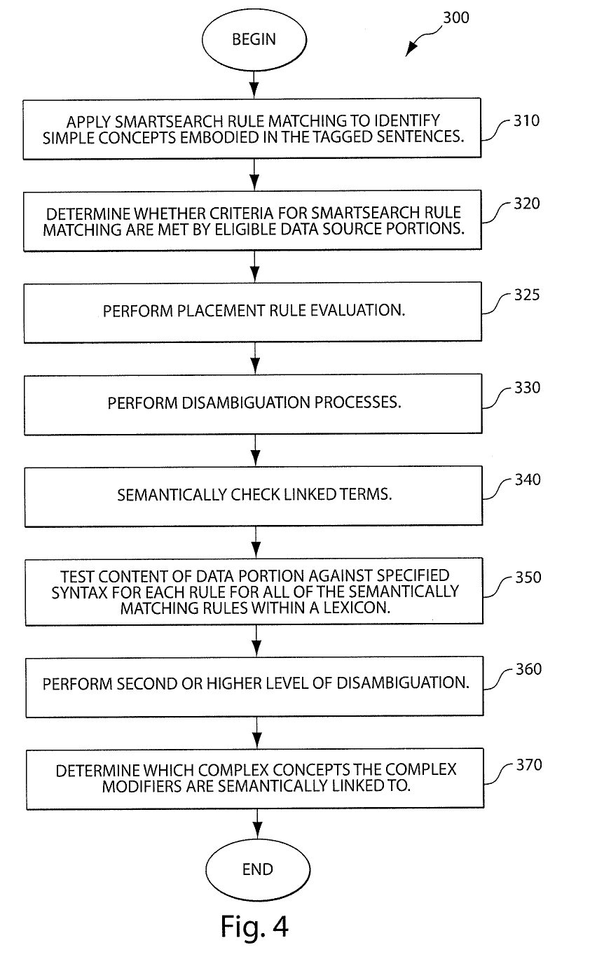

Having tagged at least one portion of the source data, concept identification is performed 220 on the tagged portions. Particularly, simple concept placeholders are applied to the tagged sentences to identify source data portions (e.g., sentences) that contain relevant simple concepts. Identifying the presence of simple concepts is performed, in some embodiments, through performance of several intermediate processes as more particularly shown in FIG. 4.

FIG. 4 illustrates a flowchart of an exemplary simple concept identification procedure 300 constituting part of the multi-stage NL processing procedure 200. Concept identification includes applying 310 so-called SmartSearch rule matching to identify simple concepts embodied (or described) in the tagged sentences on which concept identification is performed. In some embodiments, SmartSearch rules determine whether lexicon criteria have been met. Specifically, a determination is made 320 as to whether criteria for SmartSearch rule matching are met by eligible data source portions (e.g., pre-tagged sentences identified through performance of the tagging process). Tagged portions of the data source are thus processed to identify the presence of abstract placeholders within those pre-tagged data portions. The abstract placeholders correspond to more refined matching of the content of the data portions than that performed during the pre-tagged identification process. Thus, at this stage, a more complete determination of the content parts of the pre-tagged portions of data is performed to begin identifying concepts embodied within the tagged portions. Specifically, some or all of the words in the pre-tagged data portion are matched to abstracts or concepts that correspond to general meanings associated with the words being matched. In some embodiments, all the content (e.g., words) contained in the pre-tagged data portions are further processed to match (or associate) those words with abstract/concept placeholders. Additionally, in some embodiments, identification of the words and their relationship to other words within the pre-tagged data portion (e.g., nouns, verbs, adjectives) may also be performed. The initial match (to check for simple concept matching) involves both abstract placeholders as well as other terms (or synonyms of these terms) within the source text that are not abstractions.

The SmartSearch rules-based processing performed on the pre-tagged data portions does not, however, test, or match the recognized terms (i.e., terms matched to the various abstracts/concepts defined through the SmartSearch rules) to specific ontology rules. Rather, ontology-rules-based processing may be performed at a subsequent stage. Particularly, the system first determines whether the required terms and abstractions are present. Next, the system determines whether the terms and abstractions are present in the required syntactic order. Before a SmartSearch match is further refined to test whether syntax constraints are met, placement rules may be applied to determine if the matching terms are in fact eligible to be used together as a unit in the first place. If placement rules are met, then the syntax specified by the SmartSearch rule is applied to determine whether or not there is a match. The unit of analysis may be a sentence, portion of a sentence (determined by delineators), two or more sequential sentences (“sentence joining” rules), or topic heading, graphical representations or table contents alone or in combination with sentences/phrases.

Having matched some or all of the content of pre-tagged data portions to abstract placeholders and other tokens, the data portions so processed are subjected 325 to placement rule evaluation. Placement rules determine which terms within the sentence are linked (or associated). In other words, the pre-tagged tokens and abstract placeholder matched data portions (e.g., sentences/phrases) are fragmented according to a presence of a relationship among the various tokens and their related modifiers. Placement rules are applied to identify which words within the sentence are semantically linked. In the medical side-effect example used herein, the placement rules are used to determine, for example, that the first occurrence of the term “excessive” is linked to “thirst” and that the second occurrence “excessive” is linked to “urination”. An exemplary SmartSearch rule that identifies “excessive thirst” as being associated with the “increased thirst” lexicon may be, for example, the following rule:

[drink,fluid,water],[want,need,feel,keen]
NOTALL EXACT disturbance
Polydipsia
thirst,[increase,excessive]

The brackets indicate that any of the enclosed terms (separated by a comma) will satisfy the requirements. The comma between “thirst” and “[increase, excessive]” indicates that any order is acceptable whereas a . . . (three periods in a row) indicates that the order is specified by the order in which the terms appear within the SmartSearch rule. Also, the comma and three periods in a row specify that the terms do not have to be contiguous within the text but can be separated by other terms. In the above exemplary rule, there are no delineators. As for the syntax “NOTALL EXACT”, this syntax is an example of a disambiguator (at the lexicon-level rather than at the global or rule-level).

Another exemplary SmartSearch rule is the rule that may be applied to the data portion to identify “excessive urination” as a member of the “excessive urination” lexicon. The applied rule may, in some embodiments, have the following format:

diuresis,excess
increase,EXACT urination,NOT sugar,NOT prostate
NOTALL increase...urinary...excretion
NOTALL increased,EXACT urinary
NOTALL potassium
urine,EXACT excessive,NOT sugar,NOT prostate

The term “exact urination” indicates that synonym substitutions are not acceptable. The syntax “NOTALL” indicates a disambiguator but with synonym substitution allowed. In contrast, the “NOTALL EXACT” constraint specifies that synonym substitutions are not allowed. The “NOTALL” format applies to the lexicon level and to all rules within a lexicon whereas the “not sugar” and “not prostate” apply only at the level of the SmartSearch rule to which they are attached and not to the lexicon in its entirety. If the “not sugar” were separated from “excessive” by a series of three periods, it would represent a delineator rather than a disambiguator. The portion of the sentence/phrase beyond (or in some cases, before) the delineator are excluded from analysis by the SmartSearch rule.

An exemplary placement rule that establishes that “increase” and “urination” are part of the same semantic unit in the sentence may have the following format:
PLACE(UDLIST) (PLACE(PREP))?PLACE(SELIST)

In the above placement rule example, the syntax “PLACE(UDLIST)” causes a determination to be performed of whether a combination of the one or more of the words “increase” or “decrease” is present. First, the placement rules check to establish if certain combinations of terms (and/or their synonyms) are present in the phrase that is being tokenized. Placement rules have been customized for several major categories of concepts such as increase/decrease, location/body area, specific modifying concepts, etc. Therefore, the first step in testing whether placement rules might apply is checking for the presence of tokens/words (either contiguous or separated by other text) or phrases (in specified syntactical order) for each of the placement rules subcategories. If this first level of matching is met, the next step involves identifying whether any of a pre-specified list of terms/phrases or abstract placeholders (customized to the category of placement rules that has been identified) are present in the source text as well. In other words, this pre-specified list indicates which tokens are eligible for combination with pre-specified terms/phrases (and their synonyms) related to the category of placement rules under consideration. Terms/phrases/text that are eligible for combination can be specified to a level of detail that includes inflection, part-of-speech, syntax and all of the other SmartSearch functionalities.

With reference to the placement rule “(PLACE(UPDOWN)(\( . . . \))? PLACE(ANDOR) )?PLACE(UPDOWN)(\( . . . \))?” the syntax “(place(updown)” and “place(andor)”, separated by a question mark, indicates that a list of tokens that are connected by specific types of punctuation or conjunctions are allowed. If spaces rather than a comma or period were used between the above notation, this would indicate that a match would result if the tokens of the processed source data are contiguous with no intervening terms between them.

In sum, therefore, placement rules first look for a semantic/syntactic match that indicates whether placement rule application is appropriate and identifies which subgroup of placement rules should be applied (this is effectively a type of a complex initial tag). Next, text is evaluated to see if certain types of tokens that are eligible for combination with this type of placement token are present in the text. If so, the appropriate set of placement rules are tested against the text for match. Placement rules use all of the notation available within SmartSearch rules, but in addition they also specify, when tokens are not contiguous, which specific tokens or categories of tokens (that are not semantically related to the concept of interest) either must, or may sit between identified tokens of semantic interest. In some embodiments, placement rules may also be used to combine multiple abstractions at one level and summarizing them as a single abstraction to use at the next level of processing. In some embodiments, there may be two level for a given placement rule processing.

Note that, in relation to the medical side-effect example, the system can successfully determine that neither of the terms for “excessive” are linked or associated to other words in the sentence such as “hypovolemia”, “lightheadedness” or “syncope”.

As a further illustration, an exemplary data source portion may state “increasing blood pressure may be accompanied by a temperature drop and a higher blood sugar but not decreased calcium levels”. In this example, the system is configured to accurately assign, through application of the one or more placement rules executed at 320, the “increased” and “decreased” modifiers to the words “blood pressure” and “calcium levels”, respectively.

Having performed placement rules processing on the tagged and abstracted data portions, a disambiguation process may be performed 330. In some embodiments, the disambiguation process may be one of several sequential disambiguation processes used to refine the meaning assignment (or classification) performed on the content of the data portions being processed. Simple concepts may first be disambiguated by application of disambiguation rules contained within the SmartSearch rules that are associated with each simple concept lexicon. It is to be noted that the simple disambiguation rules may occur after application of the placement rules, and that the simple disambiguation rules are one aspect of the SmartSearch rule application.

Simple Disambiguation rules, for example, include colloquialisms, negations, and semantic/syntactic rules of exclusion that can be specified as global (i.e., applied to all lexicons), lexicon specific, SmartSearch rule specific, or even exclusions that are specific to a term/Abstract Placeholder within a specific location in a SmartSearch rule.

With reference to the medical side-effect example used herein, simple disambiguation rules may be applied to determine if any of the side effects that otherwise match should be dismissed because they are idioms, negations, are presented through an incorrect part of speech or tense, or for any other reason In that example, the simple disambiguation rules are not matched to the content within the sentence, and thus all of the potential side effects are eligible for matching with the simple concept ontology rules.

It is to be noted that disambiguation rules may be applied at different points during the process, depending on whether the disambiguation rules are global, whether they are lexicon specific, or whether they are SmartSearch rules specific. Global disambiguation is applied after the first level of tokenization. Lexicon-specific rules are typically applied prior to placement rule testing.

In circumstances in which it is determined that simple disambiguation rules do not apply, linked terms are semantically checked 340 against SmartSearch rules that belong to each branch of the ontology associated with the data portion being processed. The data portion is assigned to a particular ontology branch if it matches both SmartSearch and placement rules, with placement rule checking applied approximately mid-way through SmartSearch rule matching.

Specifically, SmartSearch rules are applied against the pre-tagged texts that contain required Abstract Placeholders to determine if the remaining semantic and syntactic requirements of any of the lexicon SmartSearch rules are met. Additionally, criteria can be met if Exact Term matches are present (and disambiguators criteria are not met). Semantic matches may be tested in the order of: abstract placeholders (order specified for the different classes of placeholders), single terms, phrases, semantic equivalent groups. That is, the order in which the different categories of tokens are tested may be specified (so as to optimize the efficiency of the NLP processing). For example, when new source text is processed, it is pre-processed to determine the presence of certain types of tokens such as abstract placeholders and first level high sensitivity/low specificity tags.

The part of speech specified within the SmartSearch rule for a simple term or phrase determines which other parts of speech may be considered as meeting criteria. For example, present tense of a verb indicates that any inflection is specified. Past tense, on the other hand, excludes the use of other inflections, unless another inflection is explicitly specified as well. The formatting of phrases within SmartSearch rules determine whether or not synonyms are accepted.

In relation to the medical side-effect example used herein, the exemplary data portion being processed, which was determined to be associated with the side effect ontology, is further processed to determine if the appropriate semantic items required by the applicable SmartSearch rules are present in the sentence. If so, the next step is to test whether those matching terms are arranged according to the syntax as well the semantics specified by the SmartSearch rules. In this particular example, four side effects match the side effect ontology: hypovolemia (which matches, for example, a SmartSearch rule corresponding to “Decrease in the amount of circulating blood”, syncope (matching a “fainting/loss of consciousness” ontology concept), etc. It is to be noted that any one ontology branch may be associated with multiple (e.g., 10-30) SmartSearch rules. Only one of those associated SmartSearch rules has to match the data portion being processed for the ontology to be “true” (i.e., to match).

If all of the semantic criteria specified by a particular SmartSearch rule applied to the data portion being processed are met, the content of the data portion is then tested 350 against the specified syntax for each rule for all of the semantically matching rules within a lexicon.

Once simple concept tagging has been completed, a second or higher level of disambiguation may be performed 360 to match pre-specified complex concept lexicons that have been identified (or defined) for the particular sub-domain as disambiguators rather than as independent concepts. Different complex concept disambiguators may be specified for different lexicon sub-domains.

Several types of complex concept disambiguators may be defined and are applied in different ways. Some classes of complex concept disambiguation are used to exclude simple concepts or abstract placeholders that were included during the earlier processing performed on the data portions being processed. For example, exclusionary complex disambiguators may specify simple concepts or abstract placeholders (either alone or within complex concepts) that would be eliminated if there is a match between the particular complex disambiguator and the data portion being processed.

In other words, complex disambiguator rules incorporate the functionality to specify which portion of the source data is being eliminated—an abstract placeholder, a simple concept that stands-alone, a simple concept that is a part of a complex concept, or a complex concept in its entirety. For example, consider the source text “patients with hypertension are at risk for hypertension exacerbation with this medication combination.” In this case, both occurrence of “hypertensions” match the simple concept “high blood pressure”. The first occurrence of “hypertension” is located within a string of text that also matches a SmartSearch rule that is associated with a complex concept “Risk Factor” lexicon. Using a combination of syntax and semantic specifications, this risk factor rule specifies which of the simple concepts can be stored in the database as a “Side Effect” and which represents a “Risk Factor”. In addition, the complex concept rule specifies, in this case, that the complex concept be used as a complex modifier, and that it be attached to the primary side effect (represented by the second “hypertension”; it is to be noted that it is not attached to any of the other side effects in the source text). When the translation engine is applied to this stored data, the final output appears as follows: “side effects can include worsening of high blood pressure in people who have a history high blood pressure. In this example, two separate and independent functions are taking place. First, the simple concept (the first “hypertension”) is excluded from the side effect database (simple concept disambiguation). With the second function, the dependent (excluded) simple concept that is identified by the risk factor rule is attached to the independent side effect as a modifier. In other cases, a simple concept could be applied as a modifier of a complex concept (for example—twenty three elderly patients with hypertension developed worsening high blood pressure). In yet other examples, a complex modifier can be attached to an entire complex concept (e.g., patients with hypertension are at risk of developing surgical complications when taking thyroid inhibiting drugs).

Other types of complex concept disambiguators are used to identify complex concepts that are subset, or subsidiaries, of primary complex concepts. For example, some types of complex concept disambiguators are used as modifiers for either simple concepts, complex concepts or both (in other words, certain classes/types of complex concept disambiguators are used to exclude simple and complex concept as lexicon matches and reclassify them as modifiers of other simple and complex concepts). This reclassification results in a group of complex modifiers.

Thus, with respect to medical side-effect example, complex concept ontology rules are applied to the matching side effects to first disambiguate them. In this example, the system recognizes that the symptoms in the first half of the sentence (e.g., hypovolemia, excessive thirst, and excessive urination) match the complex concepts within the “Risk Factor” category. The terms appearing in the latter part of the example sentence do not match any complex concept disambiguation rules and are therefore not removed from the side effects category. In this example, the first half of the sentence may match a pre-defined rule within the risk factor ontology called “Condition—increased risk in patients with specific underlying condition”. When a risk factor rule matches, the identified side effects may be removed from the side effect list and reassigned to the “Risk Factor” category.

Before complex modifiers can be applied, complex modifier placement rules are used to determine 370 which complex concepts the complex modifiers are semantically linked, and whether the complex modifiers are applicable to any specific simple concept contained within a complex concept or whether it modifies the entire complex concept. The system may classify several types of modifiers, namely, modifiers that modify and exclude simple or complex concepts, and modifiers that merely modify simple or complex concepts.

Turning back to FIG. 3, once concept identification operations have been completed, sentence linking 230 is performed. Specifically, sentences that are “linked” are defined as those that contain source text that can be combined and used to meet simple or complex SmartSearch rule criteria (or disambiguation/modifier criteria) in combination. In other words, sentence linking rules specify which sentences can be used jointly to match SmartSearch Rules criteria. Sentence linking rules specify the syntax and semantic content necessary to meet sentence linking criteria. For example, sentence linking rules specify abstract placeholders, lexemes/stems/terms/phrases/linked phrases, Semantic equivalent groups, and/or syntactical relationships between the above, including their position both in and within the respective sentences.

Additionally, the system also tests 240 for complex concept matches. In some embodiments, complex concepts are matched if one or more SmartSearch rule(s) for the lexicon node (i.e., a branch of the ontology used) is satisfied (after placement rules, described above, have been applied) and simple and complex disambiguation rules fail to match.

After complex concepts are identified, SmartSearch relationship rules are evaluated 250 to determine if specific categories of relationships between the identified complex concepts are present. For example, categories include rules that establish one complex concept (or its component simple concept/s) as members of a secondary sub-class (or dependent class of information) in relation to a primary concept (or an independent class of information). Each SmartSearch rule may be specified through a specially formatted subcategory of specialized abstract placeholder tags (“CONDITION(GENERAL)” tags, for example) whether an entire lexicon or whether specified components of a lexicon (denoted by the specialized abstract placeholders, “CONDITION(GENERAL)” tags, for example) are secondary characteristics of a primary complex concept.

Thus, with respect to the “side effect” example used herein, SmartSearch relationship rules applied to the processed data portion recognize that the complex concept corresponding to the part of the data portion of “Hypovolemia, excessive thirst, and excessive urination can predispose” (i.e., the ‘risk factors’ portion of the sentence) has a secondary relationship to the primary simple concepts corresponding to “lightheadedness and syncope”. The relationship rules that evaluate the concepts thus associate the recognized risk factors to the identified simple concept of side effects contained in the sentence (namely, “lightheadedness and syncope”).

An exemplary risk factor complex concept is provided below:

NOT DRUG...CONDITION(GENERAL)...NOT EXACT
may_result_in...[may,should,MODAL]...[induce,
CAUSE]...SIDE EFFECT

In the above example, the “NOT DRUG . . . ” is a delimiter (indicates that text before it is not included in this phrase) the syntax “ . . . CONDITION(GENERAL) . . . ” specifies that the simple concept in this syntactical position within the sentence should be excluded as an independent simple concept (from within the side effect lexicon). The “ . . . ” indicates that there is positioning (syntactical) requirement for the simple concept (CONDITION(GENERAL)) in relation to the other tokens in the phrase. The last part, “SIDE EFFECT”, indicates that the simple concept in this position within the text remains a simple concept (and in fact, is specified as the simple concept which is modified by the excluded simple concept indicated by “CONDITION(GENERAL)”). in other words, the complex concept rule, by use of certain functionalities, indicates which concept is independent, which is dependent, and the exact nature of the relationship between them. In addition, it specifies which term is excluded from its simple concept categorization.

The resultant multi-stage processing of the example data portion determines that two of the initially identified four simple concepts for side effects are to be assigned as side effects, while the other simple concepts are assigned (attached) as risk factors. The resultant output, as specified below, includes:

light-headedness/faintness - especially in people with dehydration of
in a decreased amount of circulating blood
light-headedness/faintness - especially in people with increased thirst
light-headedness/faintness - especially in people with excessive urination
fainting/loss of consciousness - especially in people with dehydration of in
a decreased amount of circulating blood
fainting/loss of consciousness - especially in people with increased thirst
fainting/loss of consciousness - especially in people with excessive
urination

In this case, the drug product tells the end user that certain side effects can be caused by this drug and that these side effects are more likely under certain circumstances (if certain risk factors are present). To accomplish this, the system has to be able to distinguish which tokens in the text are “side effects” and which are “risk factors” as well as recognize the relationship between them and which concepts are dependent and independent.

In some embodiments, after performing the concept relationships evaluation, a modifier attachment analysis may be performed. Specifically, subcategories of terms/lexemes/stems/phrases/linked phrases, simple concepts, and complex concept that are eligible for modifier attachment are identified 260. Modifier placement rules specify which modifiers and concepts are semantically related and should be attached. Different placement rules have been developed and are specialized according to the type of modifier and type of concept to which the modifier is attached. For example, TIME modifier placement rules differ from LOCATION modifier placement rules. Modifiers can be simple or complex, and may be attached to simple or complex concepts, or to terms/lexemes/stems/phrases/linked phrases.

### Dynamic Ontology Generation

As described herein, ontology trees (i.e., data sets that include concepts relating to one or more subject matter and the relationship between at least some of the concepts) for multi-stage NL processing may be generated dynamically by attaching certain, pre-specified modifiers to create “on-the-fly” lexicon subcategories. Text-based ontology creation enables flexible modification/customization of each Lexicon-tree used to match specific semantic content present within a data source to arrange the content in a meaningful way in a database for subsequent searching and utilization.

Customized lexicon creation enables the system to automatically prune/expand its ontology branches so that the level of complexity fits that material and so that the end-user can be presented with a lexicon set that is manageable for the purposes at hand. The more source material that is made available, the more the customized lexicon tree can be expanded and therefore can be controlled based on the amount of data covered at any one time (dictated by the purpose of the application). For example, customized ontology generation obviates the need to specify every possible LOCATION of a concept and can generate branches related to relevant locations based on those that are identified within source text. The more comprehensive the source data, the more complete the location specification. Similarly, the more circumscribed the source text (depending upon the intent of its use), the more circumscribed the lexicon will be.

The system maintains “skeleton ontology” which are sub-domain specific. The skeleton incorporates branches for major concept headings, many of which are not typically presented as a concept within lexicons/ontology without further differentiation. For example, pain might be included as a major class within a medical ontology. However, specification of pain location is typically specified as well, at least for major pain-related issues (such as abdominal pain or headache, for example). The skeleton ontology structure that provides the basic structure for knowledge-driven automated ontology creation would include concepts as general as “Pain” but would not specify body area location. Instead, the skeleton is populated only as specific pain locations are mentioned within the body of source data (e.g., source text) that have been submitted to the system as relevant to a particular sub-domain of interest. For example, if the sub-domain of interest is “drug-related side effects”, and the text submitted for tokenization is a drug-aggregator created knowledge base, then the “pain” heading within this particular ontology will include body areas that are described as being susceptible to pain/discomfort as a drug side effect. Thus, for example, headache, arthritis, back pain, painful rash, abdominal pain, etc., would be recognized within the source material and automatically added as branches under the pain heading. Other potential pain location, however, such as pain from aortal dissection, pain at a fracture site, pre-auricular pain, etc., would not be included. With the automated generation and maintenance of lists of side effect locations, streamlined customized ontology trees can be generated for each sub-domain of interest. In some embodiments, the dynamic branches, once they have been auto-generated in abstract form based on the instances within the source data may then be reused to recognize other non-abstract instances within the source data.

The value of auto-generation and of customization is multi-fold. First, auto-generation greatly decreases the scale of both development and maintenance efforts. Second, a streamlined, collapsible/expandable tree provides many protean advantages for decision-support user interfaces. The fewer branches that an end-user has to wade through, the more user-friendly the interface. In this above example, when only two variables are being considered, the user-interface difficulties are not that significant. However, if other variables are added, for example, if the user has pain in the head that is sharp and comes and goes over a few seconds, then displaying all of the possible combinations of these variable within the context of a branch procedure becomes completely unwieldy. That is why traditional ontology relationships tend to be binary or between pairs (for example, leg pain may be listed under leg; and sharp pain may be filed under pain; and pain that comes and goes over a few seconds is not listed under anything because this concept by definition implicitly includes several variable such as acuity, symptom variability; time course, etc.). With the KEEP system, however, because only the pertinent combinations of multiple variables for the domain of interest are included, all possible combinations need not be maintained or specified but can be added as they are described in the literature as occurring or as being pertinent. In addition, the skeleton does not even have to explicitly or visibly include the finely detailed branch. Thus, if the end-user goes to the branch that includes head pain, and then suggests (in their own free-form natural language entry) that the pain is sharp, and that the pain comes and goes and lasts for only a few seconds, then the system recognizes this description as a related sub-branch which then, on-the-fly, can be explicitly articulated as a known side effect of some drug. In other words, the system recognizes the attached modifiers described by the end-user and recognizes the connection to the sub-branches that have been identified as attached as modifiers to the relevant skeletal ontology branch (which directly represents adverse drug reactions). The capacity to maintain a streamlined tree that can be visually perused or scanned by either a content developer or end-user to search for their choice or selection is a great convenience. The ability to collapse tens of thousands of branches into a manageable structure while yet allowing for the display of just the right combinations of multiple variables hidden within this structure until they are specifically requested enables the KEEP system to function as a specialized, highly specific and uniquely flexible (collapsible and expandable) ontology structure.

In some embodiments, the dynamically generated ontology expands as the end-user adds more specific information about his/her condition, e.g., through a user interface. For example, in response to a query/entry such as “head pain”, a typical conventional decision-support product might display the portion of their ontology which includes “headache” whereas the KEEP system may display “headache” as a parent category with “sharp head pain that comes and goes over a few seconds”, as the more specific description of the relevant symptom for the drug of interest. In addition, if the end-user were to enter “sharp pain in my head which lasts a few seconds, a conventional decision-support system would generally recognize this as “headache” while the KEEP system described herein would recognize the symptom as a close match to the more detailed description within the medical literature.

Thus, in some embodiments, the system attaches multiple modifiers and multiple layers of modifiers to independent concepts. First, the system identifies the concepts to which modifiers may be attached. Generally, only certain classes of simple and complex concepts are eligible. The system then evaluates whether modifiers that are stipulated as being attachable to these classes of concepts are present within the text. Multiple modifiers may be identified for a single concept. Certain simple concepts are eligible for modifier attachment, as are certain pre-specified complex concepts. Ontology generating rules, which are similar in their functionality to SmartSearch rules, have a structure that enables the rules to indicate whether the modifier is attached to a simple concept or to a complex concept (which incorporates a simple concept) in its entirety. If the modifier is to be attached to a simple concept, the simple concept is generally described by an abstract placeholder within the modifier rule.

If both the modifiable simple concepts and their contender modifiers are present within the text segment, modifier placement rules are then invoked to establish whether the modifiers and modifiable words are semantically related. If they are, then the next process is to test whether the modifier rules syntax constraints are met as well. If so, based on the formula specified within the context of the modifier rules, the modifiers are attached to either the simple or complex concepts.

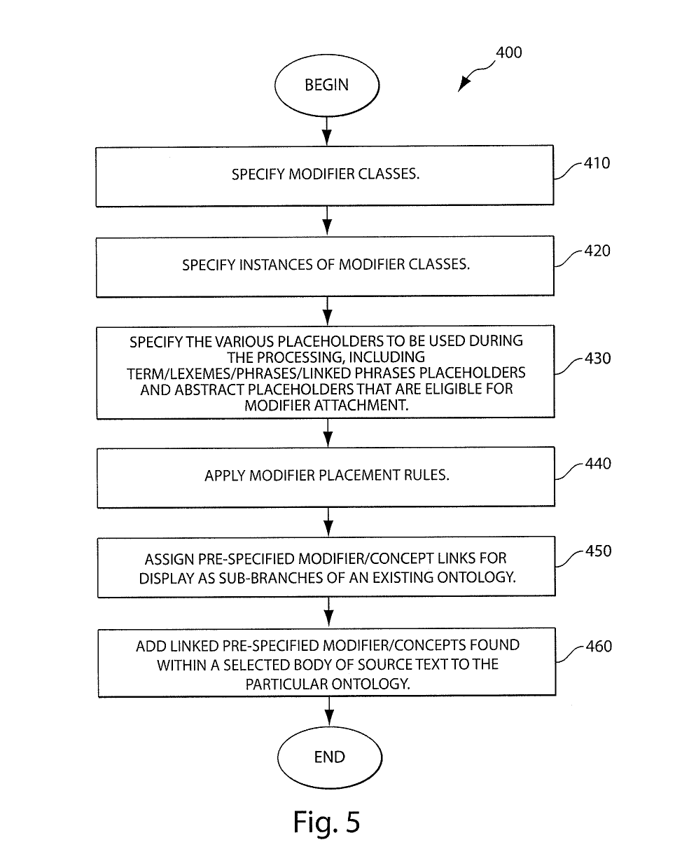

Thus, referring to FIG. 5, a flowchart of an exemplary dynamic ontology customizing (generating) procedure 400 is shown. Initially, modifier classes are specified 410.

Having defined the modifier classes, instances of modifier classes are specified 420 (both Abstract and Specific). Subsequently, the various placeholders to be used during the processing, including term/lexemes/phrases/linked phrases placeholders and abstract placeholders that are eligible for modifier attachment, are specified 430. As noted, generally, only some of the classes of simple and complex concepts are eligible to be attached to modifier, and accordingly, those concepts that are eligible are first identified and/or specified.

Modifier placement rules are then applied 440 which establish the linking between specific modifier classes, and the pre-specified categories of simple and complex concepts.

Following the application of the modifier placement rules, pre-specified modifier/concept links are assigned (attached or ear-marked) 450 for display as sub-branches of an existing ontology.

Linked pre-specified modifier/concepts found within a selected body of source text are added 460 to the particular ontology.

### Applications

The raw data processed by the KEEP system is organized into Decision-Support Knowledge bases can be accessed and utilized by users (e.g., patients, physician, pharmacists, etc.) to obtain relevant information for medical queries (which may be inputted in natural language). In some embodiments, organizing data into the knowledge-based system can be implemented by creating pointers to the source data that are stored in a relational database in searchable format based on the NL processing performed on the source data.

The KEEP system described herein enables automating the process of knowledge-base construction at reduced cost (e.g., computational cost). For example, what would have taken 100 hours to provide without automation can be reduced to about 10-15 hours of work using the KEEP system described herein.

In some embodiments, The KEEP system enables accessing and processing private medical information for patients to determine potential problems and errors, alerting users (the patients and/or their caregivers when there is a problem or a question about diagnosis, drug interactions, treatment adequacy, overlooked follow-up, etc).

One decision-support application that has been implemented and used is the DoubleCheckMD Drugs application. The DoubleCheckMD Drugs application addresses the problem of medication-related errors. Currently, medication-related errors are the third leading cause of adult deaths in the United States. Most of these errors occur not because the wrong drugs are prescribed but because of a failure to recognize a drug problem when it occurs.

For example, consider a situation where a patient is taking six different drugs, and patient develops a problem with bruising. The cause of the bruising is often difficult, for a physician, to diagnose. Often, the cause of a problem, such as the bruising, is a drug side effect. For example, in this situation, two of the patient's medications, when combined could cause platelet dysfunction and bleeding problems. A physician may not realize that the bruising is a side effect of combining drug, but even if the physician did realize that, it would be difficult for the physician, using traditionally available medical sources to diagnose the problem. Specifically, the physician would have to look up 21 different drugs/drug combinations (six drugs and 15 combinations) which would take an amount of time that physicians do not have.

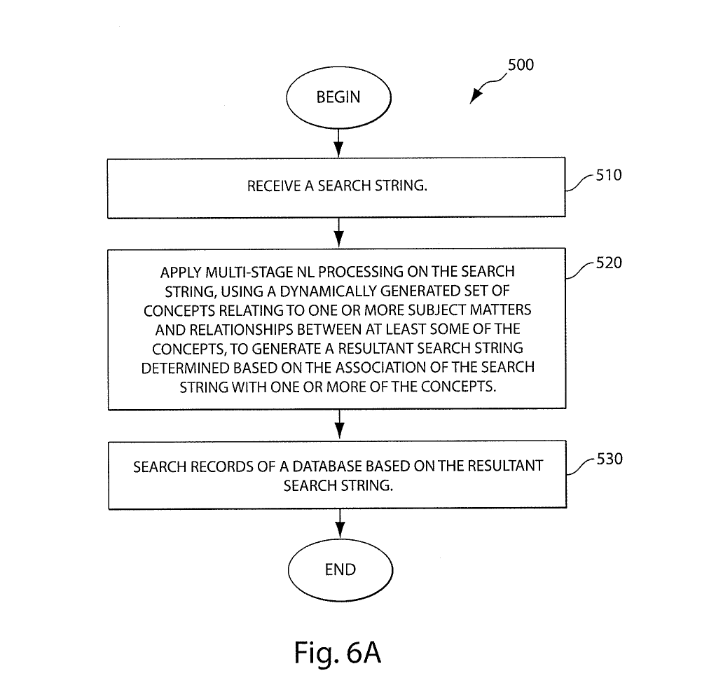

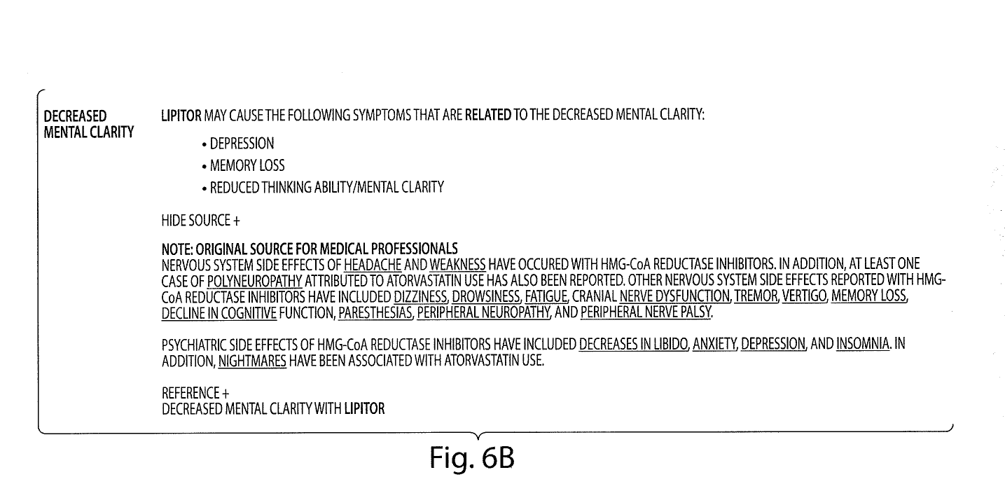

As described herein, by using a decision-support application such as DoubleCheckMD Drugs, the relationship between the bruising and drugs can be quickly identified. A patient (or his/her caregiver) would provide, through a user interface (see FIGS. 6A-6SS) the drugs taken by the patient, as well as the symptoms experiences by the patient. For example, the user could input through the user-interface a query indicating that the patient is having a bruising problem. Entry of the query can be done in natural language (i.e., the problem could be described in the same way a patient might describe his/her symptoms to a physician or a friend, e.g., “I'm having a lot of blacks and blues”, “I'm bruising”, etc.). As explained above, the application is configured to recognize search terms in context. That is, in relation to the other words in the sentence that change or fine-tune the meaning. Upon submission of the query, the system processes the query by applying to the query operations similar to those used to process data portions that were to populate knowledge-based systems (e.g., by performing the operations described in relation, for example, to FIGS. 3 and 4) to determine the meaning of the submitted query. The processed query is then submitted to the knowledge-based system (which includes a database or repository populated with previously processed data from various data sources) and scans the knowledge-based system, constructed using the KEEP system, to perform and complete the query (e.g., identify the cause of certain specified medical symptoms).

More particularly, the application processes the query (e.g., applying the SmartSearch rules as it would to any data source) and identifies the semantic content and matching of ontology branches (including any identified modifiers that are semantically attached to the concept, and that would auto-generate a child branch). The application database then matches the ontology branches (or concepts) identified as related to the query with ontology branches (concepts) identified within the context of the source data (stored in the knowledge base).

Several levels of relationship are defined. The first level is an exact match of auto-generated ontology branch which includes all modifiers. The next level is a matching ontology branch with overlapping modifiers. The third level includes the parent ontology branch that subsumes both the query and knowledge base ontology classifications. A fourth level is defined by cross-ontology relationships that have been established for a domain-specific ontology tree. The KEEP application maintains a secondary ontology tree that cross-references relationships between ontology branches that are not displayed in the simplified skeletal ontology. To keep the ontology structure a manageable size, the skeletal ontology does not automatically display all possible connections/relationships between the various branches, even though these relationships are maintained within the database. For example, hepatic encephalopathy and elevated blood SGOT are not displayed within the same branch within the ontology (one resides in the abnormal blood test section while the other resides under liver disease and abnormal brain function) but the system recognizes that there is a relationship between these concepts. Moreover, a degree of relatedness is maintained within the database. Another innovation is used by the KEEP system to identify relationships between ontology concepts and is described as follows: as the KEEP application analysis establishes complex concepts, output includes specified relationships between the simple concepts. For example, the KEEP system may analyze the free text sentence fragment “symptoms of encephalopathy include headache, nausea, vomiting, vision changes . . . ”; it then identifies the simple concepts of “headache”, “nausea”, etc.; identifies a relationship to the independent condition “encephalopathy”; recognizes the relationship as belonging to the complex concept “specific clinical findings associated with a specific condition”. Therefore, if an end-user inputs symptoms that include nausea, the KEEP database could match this simple concept to the condition “encephalopathy” through the complex concept relationship “specific clinical findings associated with a specific condition”. In other words, the KEEP system “learns” about new associations/relationships, automatically populates the instances identified by these relationships into the KEEP concept relationship database, tagging these newly created concepts by applying SmartSearch rules, and then refers to these newly created concepts and their relationships to the complex concept whenever an end-user enters a search term into the application. In the example, for drug information product, the application is able to recognize relationships between conditions and symptoms that might be missed by those versed in the presentation of the condition.

By decreasing the chance of missed relationships, the KEEP application is configured to significantly decrease the chance of errors of oversight and omission. Thus, for example, if a drug side effect is stated as “encephalopathy” within source text and the end-user states that he/she is suffering from “decreased mental functioning/confusion”, whereas even the clinician might miss the connection between the side effect that is listed in the text and the stated symptom, the KEEP application recognizes that there is a relationship and presents this relationship to the patient/healthcare provider for consideration.

In some embodiments, the DoubleCheckMD Drugs decision-support application may also indicate, in the output provided to the user, suggested treatments and/or other courses of actions (e.g., suggestions of blood tests to confirm the diagnosis provided by the DoubleCheckMD Drug application). This is accomplished through display of complex concepts identified within the source text that recommend actionable interventions if certain circumstances are present.

Another decision-support application that uses knowledge-base databases constructed using the KEEP system described herein is the DoubleCheckMD Decisions application. This application provides consumers (e.g., patients) with a personalized virtual second opinion about their treatment. A consumer interacts with the system like he/she would with a physician, answering questions about his/her health problems. The system then provides highly individualized feedback (assembled from evidence-based information) about the adequacy of the treatment and about treatment options/next steps if current treatment results are not satisfactory. The DoubleCheckMD Decisions application provides users with focused actionable information that is specific to individual health situations as input by the user. The DoubleCheckMD Decisions knowledge base, like the drug product knowledge base, is auto-populated with data derived from application of the KEEP application.

As noted, the KEEP system is used to pre-populate decision-support (DS) knowledge bases (KB) with information that can be delivered to end-users. Thus, information for such decision support knowledge bases does not have to be populated by humans.

The DS systems are configured to deliver highly personalized/individualize information that is targeted to the requirements of the end-user dynamically. The decision support systems enable end-user (e.g., patients, physician, etc.) to state a request or a question in a non-structured manner, using natural language. To accomplish this, as well as employing the KEEP system to identify the semantic content of medical literature to pre-populate a static database, the KEEP NLP capabilities are also used to tag and codify natural language text provided by the end-user that specifies the data and requests provided by the end-user. Based on the semantic content determined to reside in information provided by the end-user, the KEEP system dynamically triggers linked sections of information/data that is stored in the database. The innovative DS support tools described herein, in other words, are not only unique in use of NLP to auto-populate databases, but are also unique in linking DS knowledge output to dynamic NLP processing of end-user input.

In addition to providing static domain-specific knowledge that resides within the DS database, KEEP also functions dynamically, during the end-user interaction, to provide immediate targeted information in response to end-user queries/data.

In addition to enabling the end-user to interact with the DS system through natural language input and to receive information that is dynamically personalized based on their input, the DS system displays information or choices to the end-user that may not directly address their query/input but may be useful in that it may be related to their query.

To achieve the latter functionality, once the end-user enters his/her data into the data entry box in the GUI, the KEEP system runs the data through its engine, tags the end-user entry as it would free-text and runs KB rules against the end-user text, classify it according to instantiated Basic Concepts and Compound Concepts described above. After tagging the user input, this input is matched to the concept ontologies, taking into account the dynamically created branches and the modifier tagging applied to the user query. If there is not an exact match, the user query (in its modified form) is tested against related ontology branches. Thus, not only does the KEEP system store identified classes from the Knowledge Representation tree, it also stores classes that are related to those that are instantiated. Related classes include a parent or child constructions if the instantiated branch is within the ontology structure. In addition classes are also considered related if one or more of the constraints within a specific Knowledge Representation rule are satisfied (even if the entire rule is not satisfied). In other words, the system determines which rules are partially satisfied. A hierarchical rules-based engine establishes the “goodness-of-fit” or level of match of these partial matches. Then, in response to the natural language queries/data input by the end-user, the database offers-up output/information ranked according to the closest to least close matches.

Partially matching output is delivered at several stages, particularly, during the end-user data input stage to suggest other possible inputs, and during the system data output stage where possible related information is made accessible to the end-user to broaden the scope of viewable information.

In addition, the KEEP dynamically visually tags text/information that is delivered as output to the end-user so that the end-user can visually see the exact and partial matches that have been identified within the context of the original text.

As explained, the DoubleCheckMD Drugs application enables end-users to enter symptoms/problems that they are experiencing and query the system about whether their medications may be the cause of their problem. It also checks for potential drug interaction, drug contraindications, and incorrect dose or route of administration. The product offers a translation of source text from medical terminology into language that is readily understandable to a non-professional end-user.

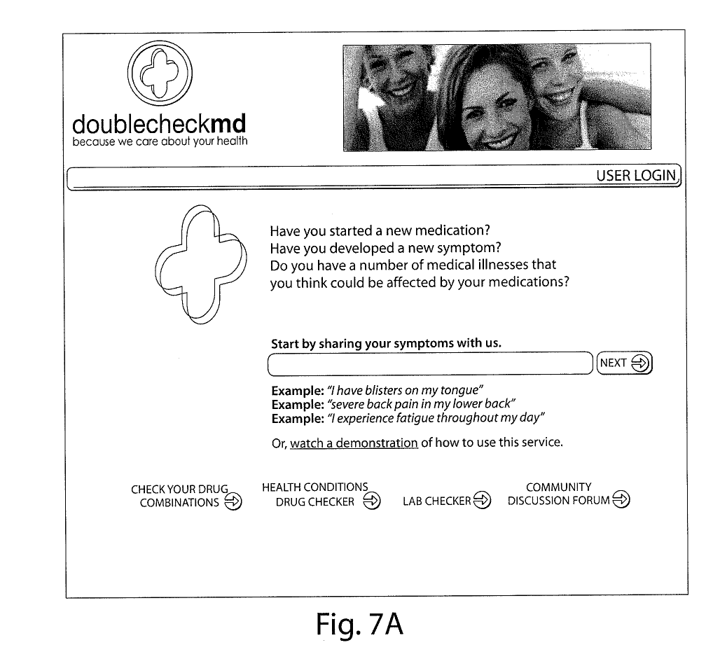

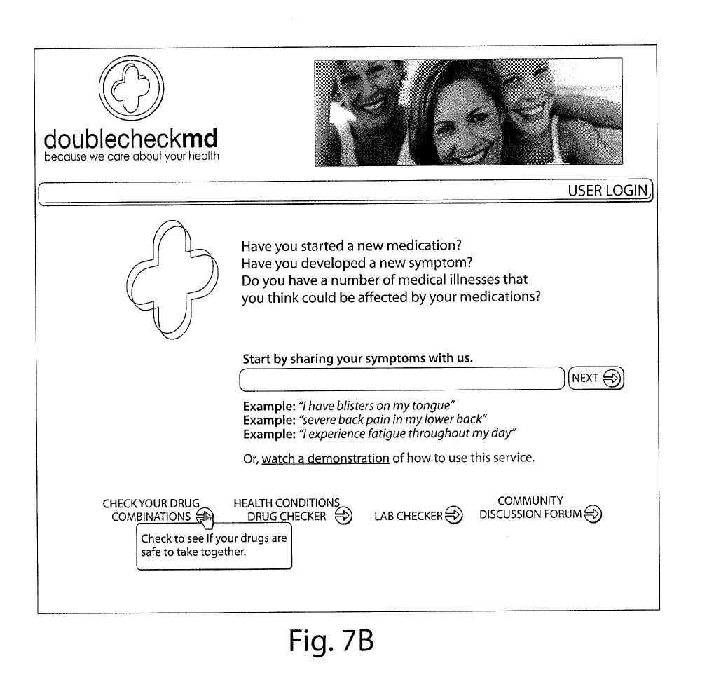

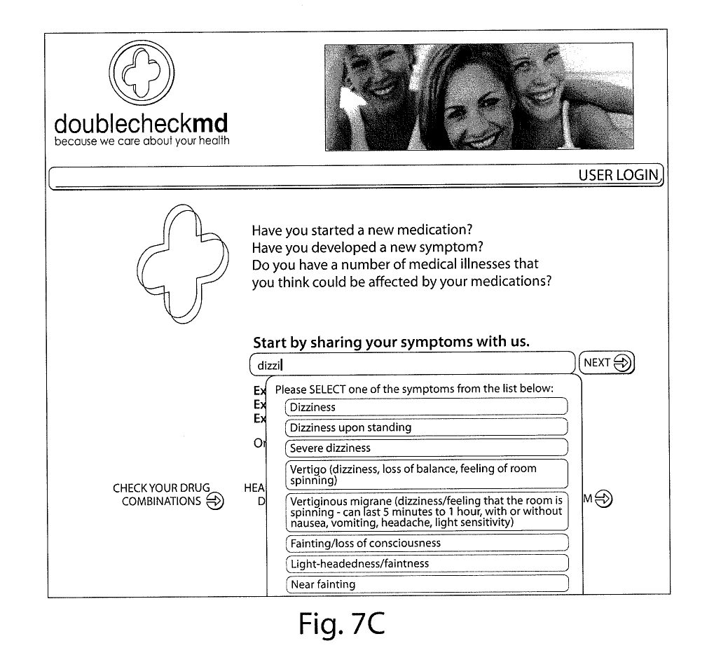

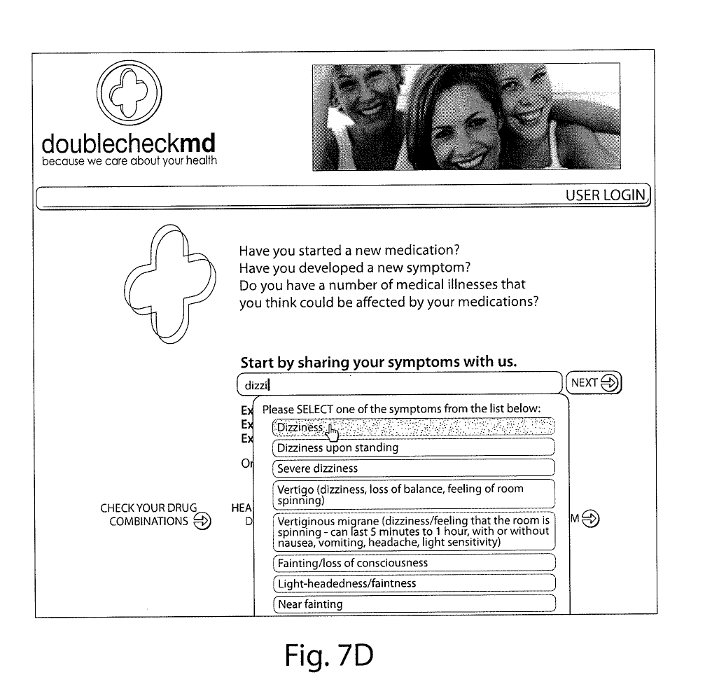

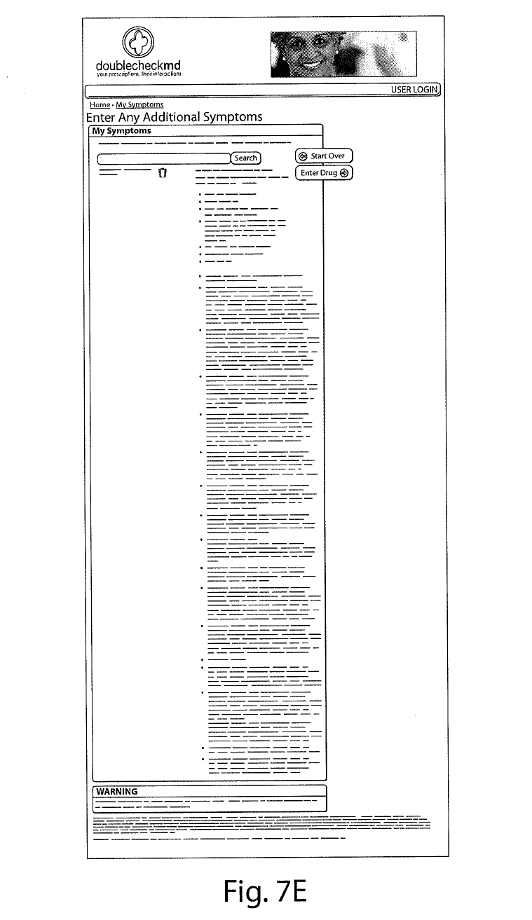

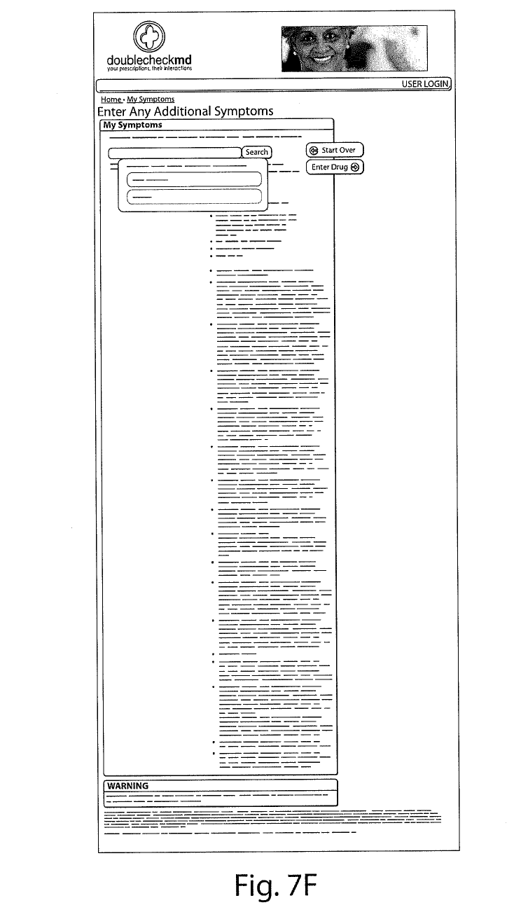

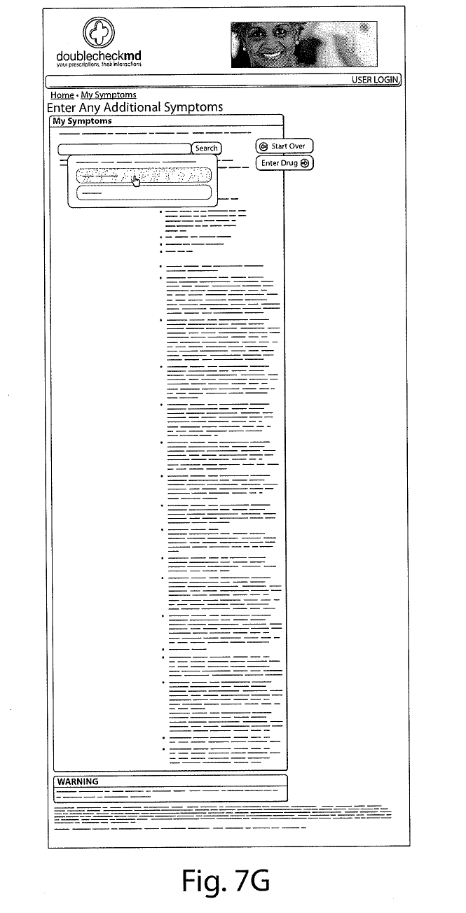

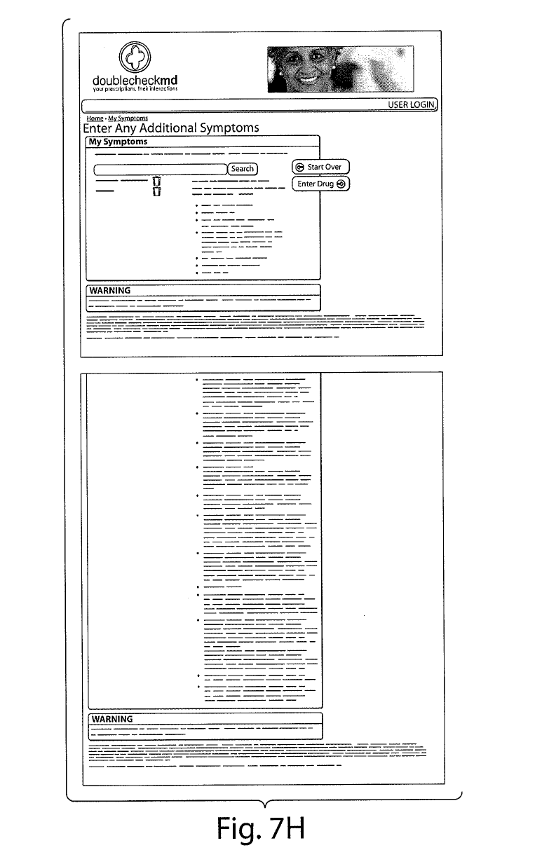

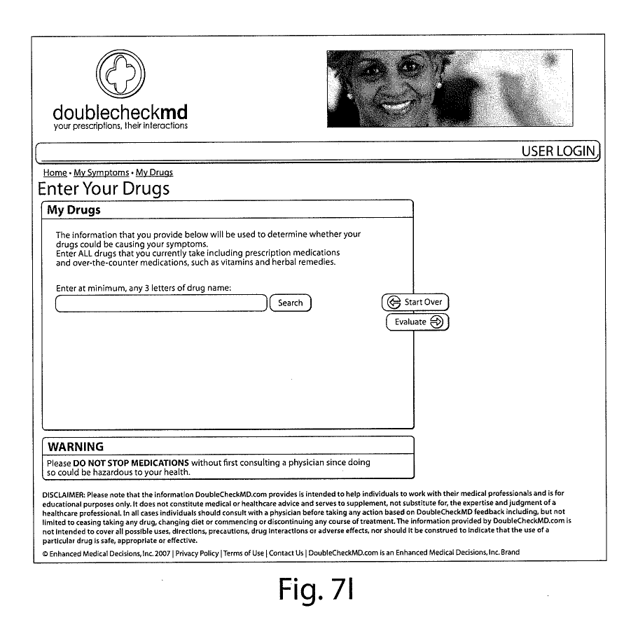

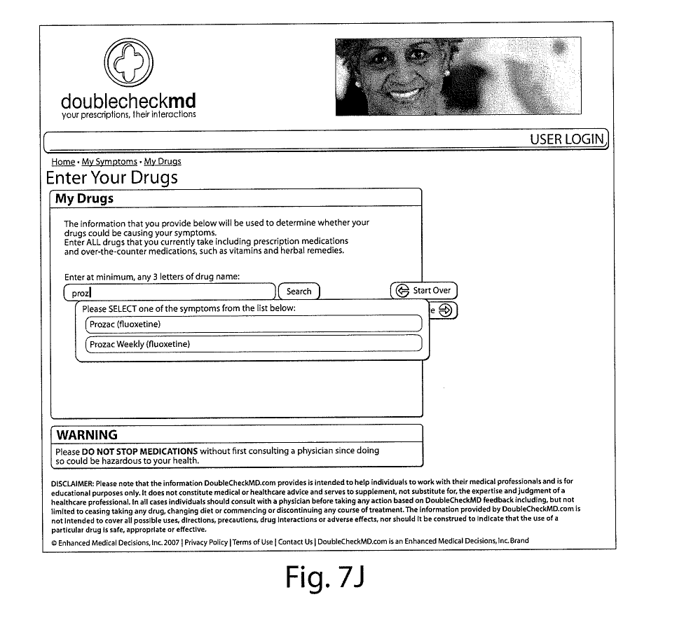

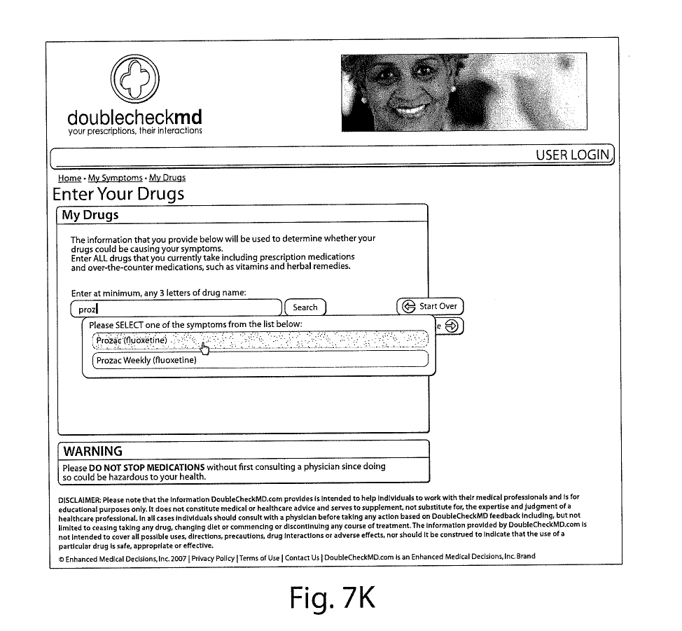

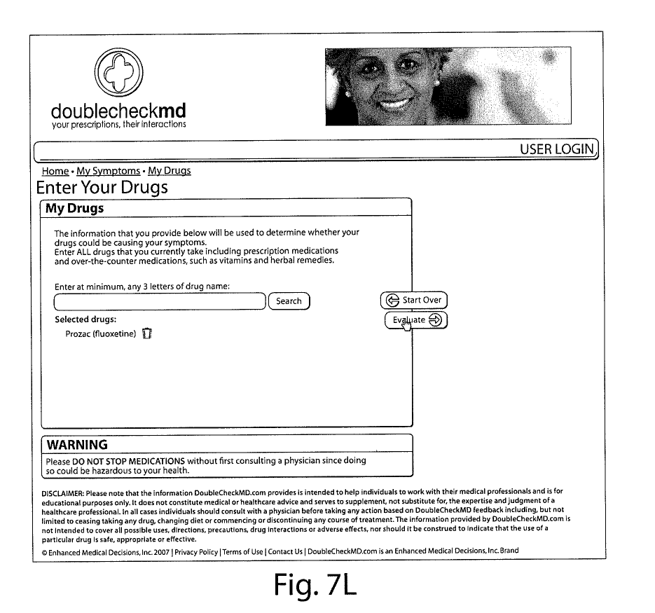

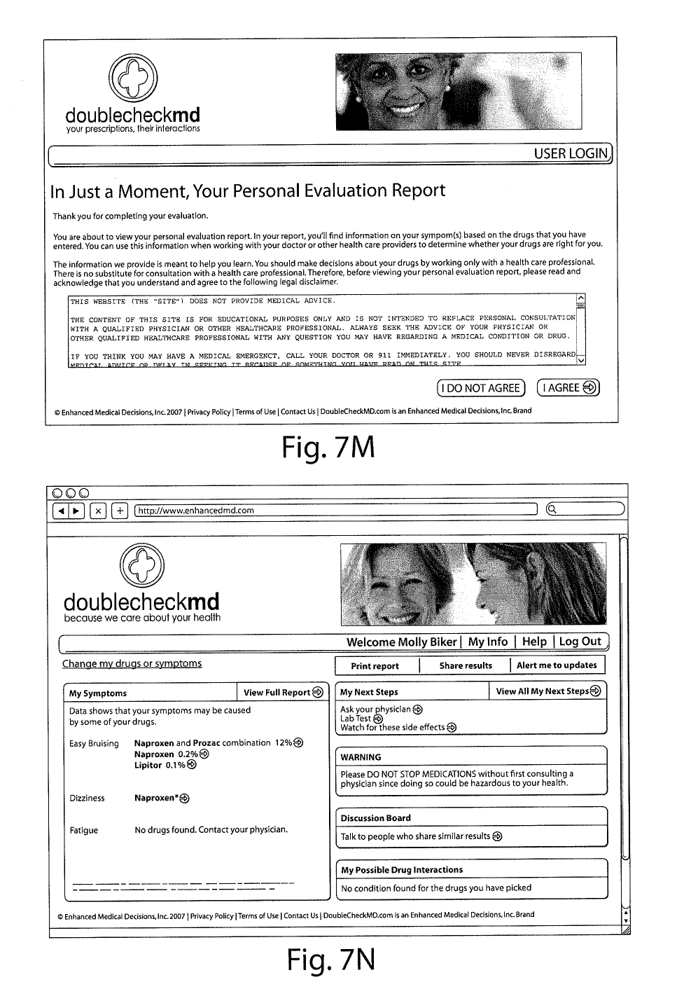

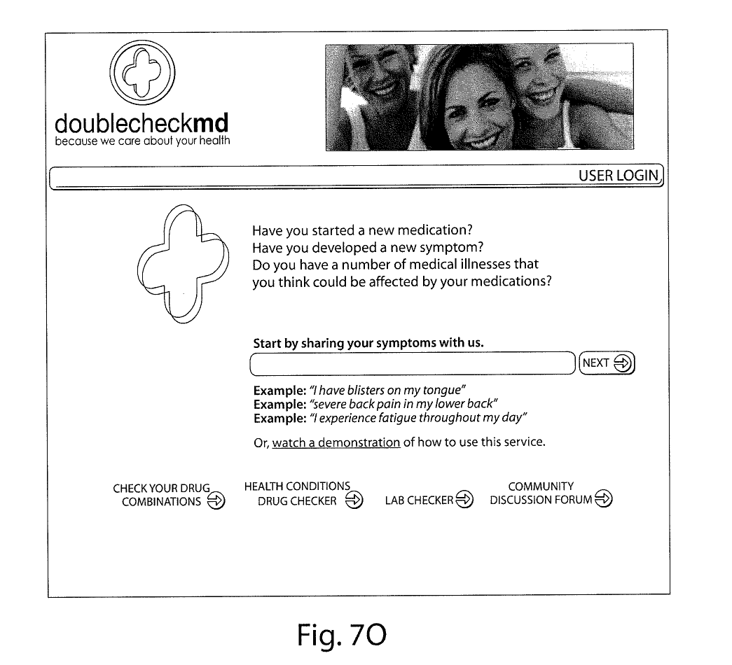

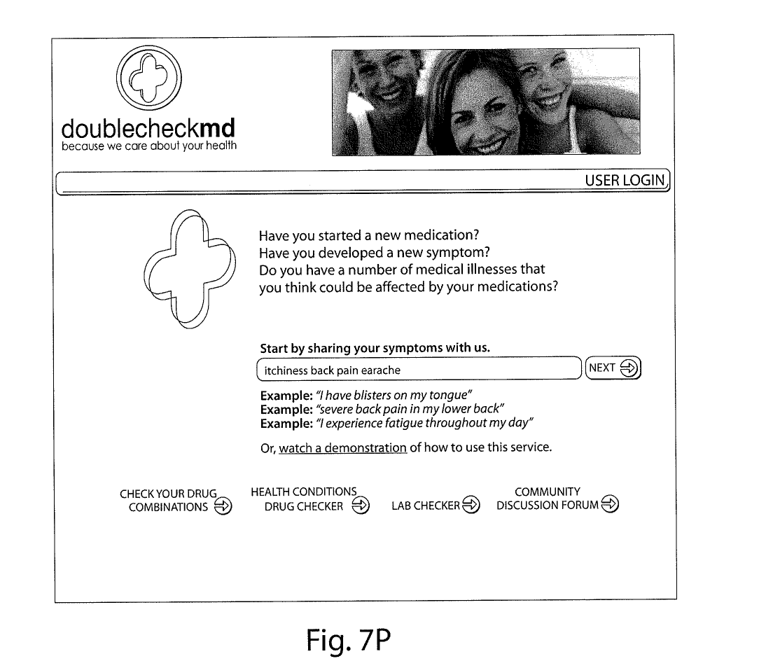

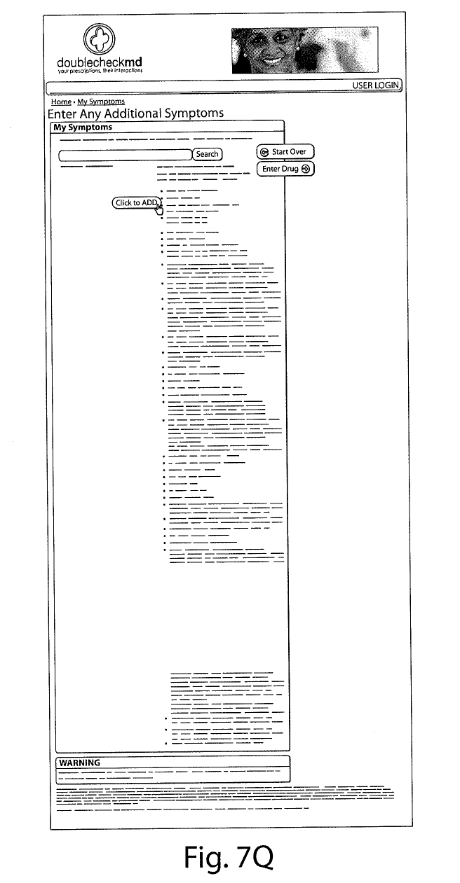

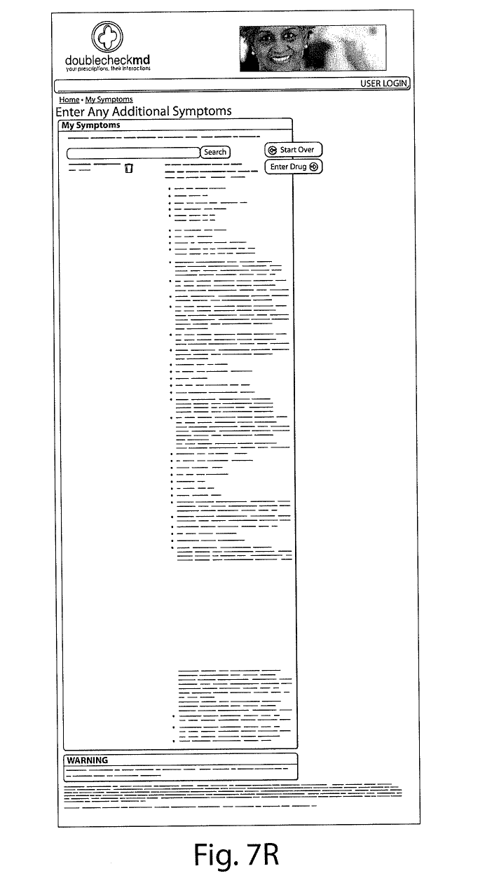

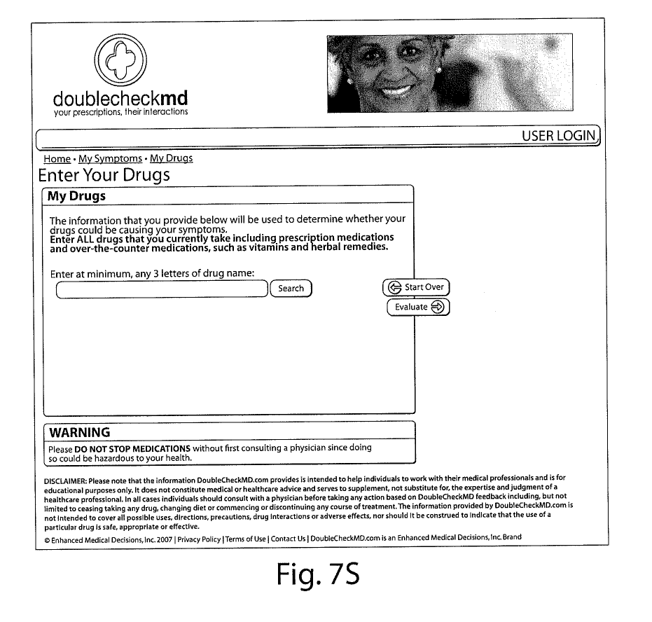

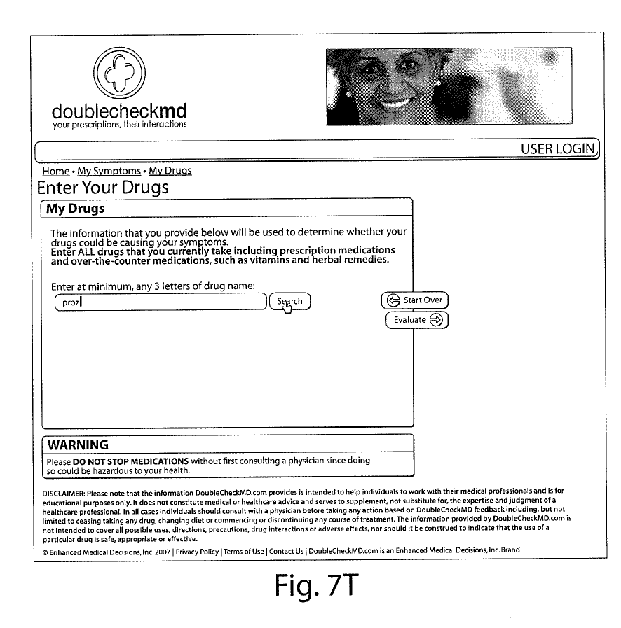

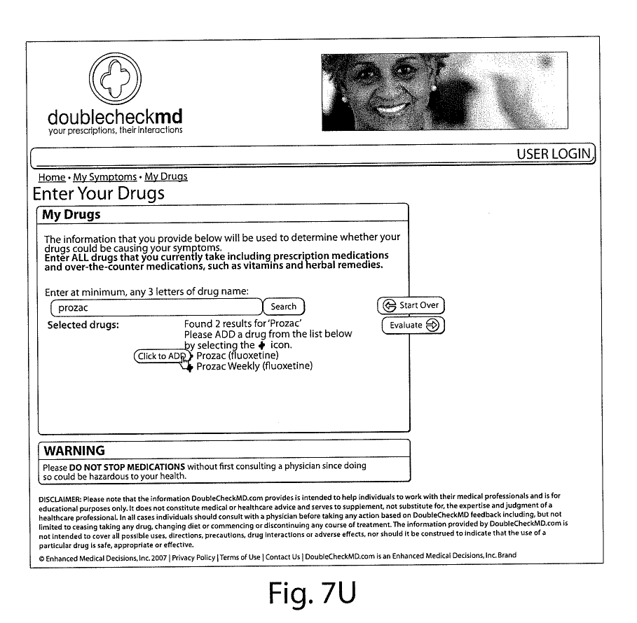

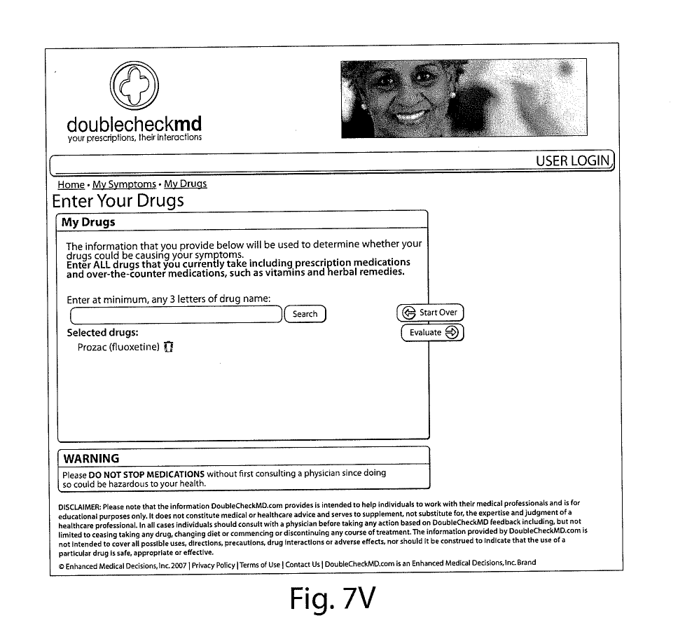

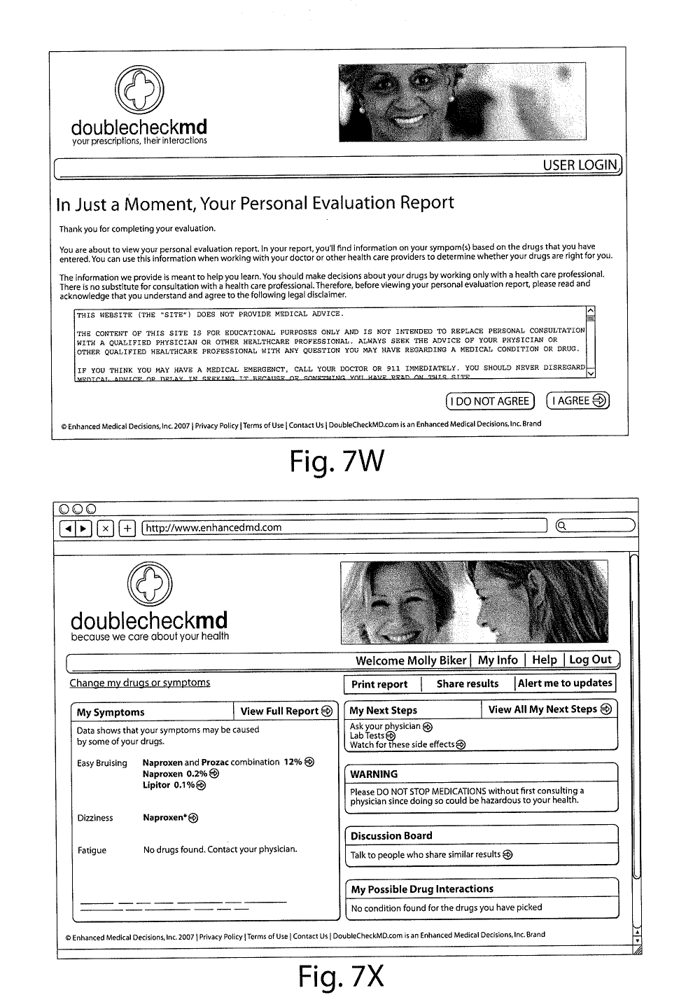

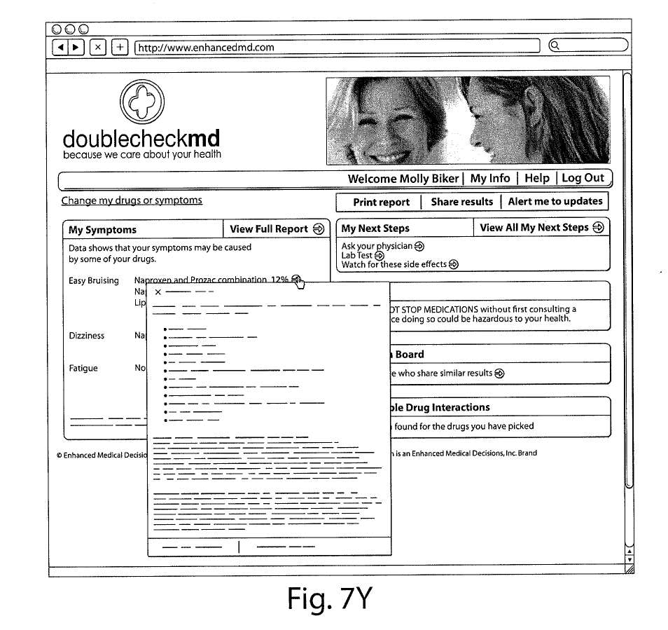

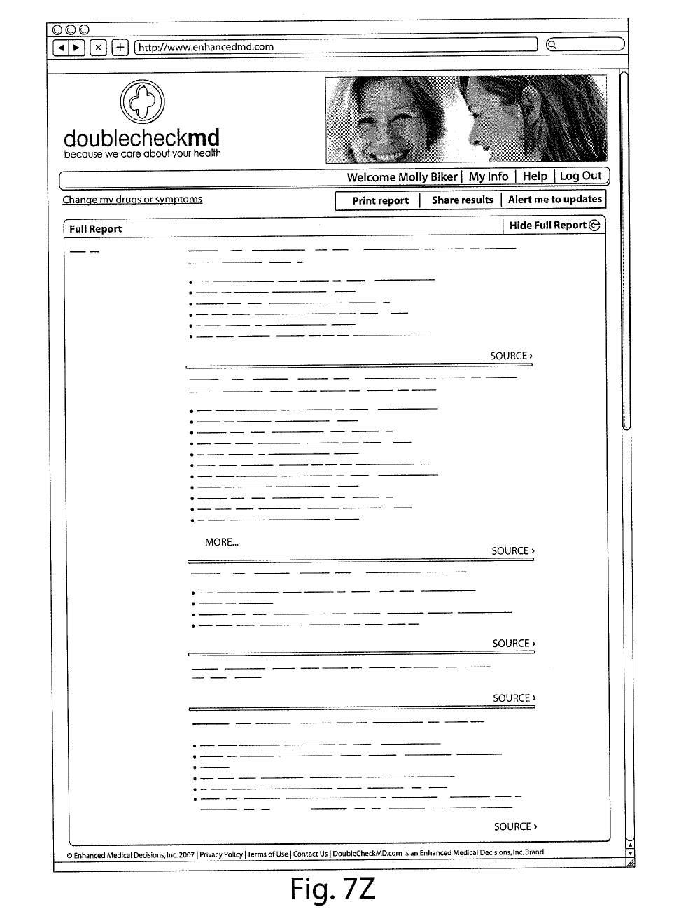

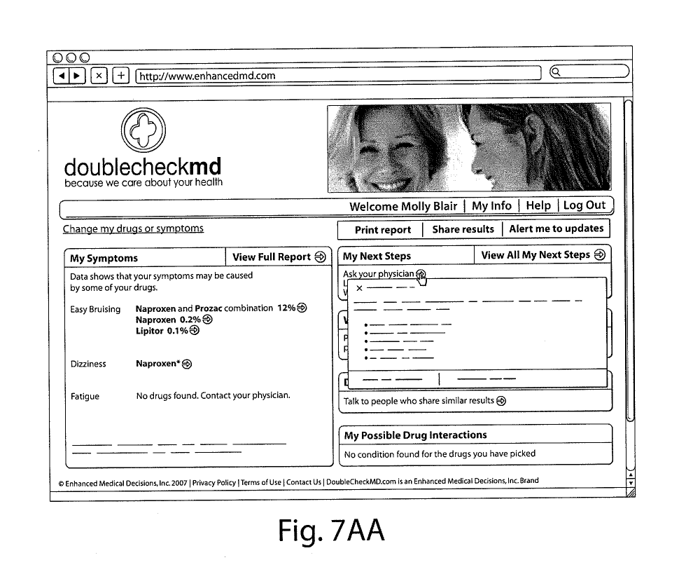

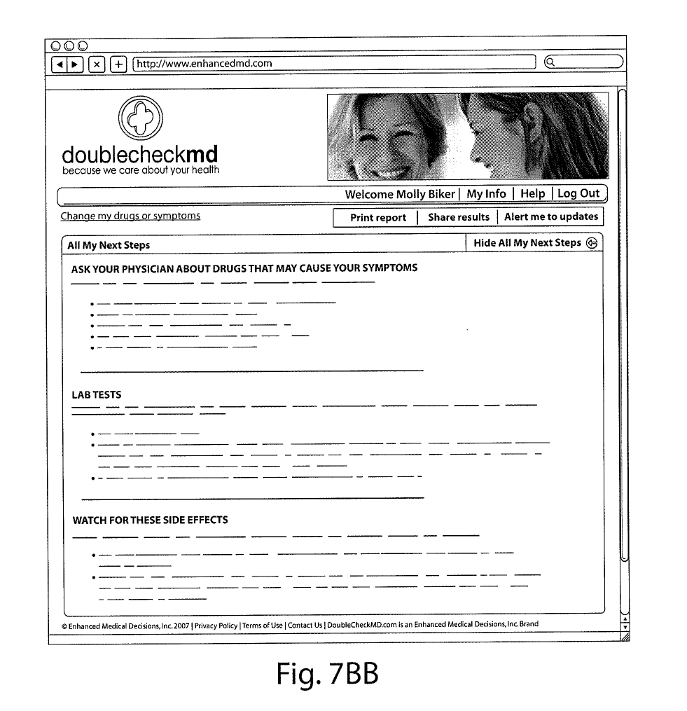

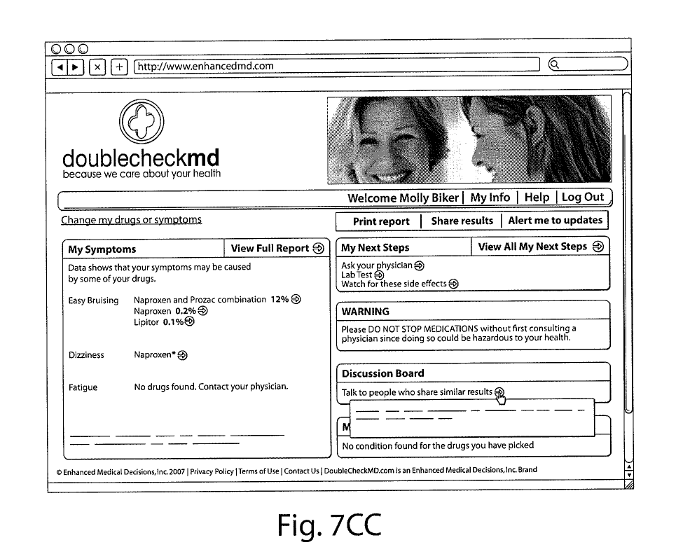

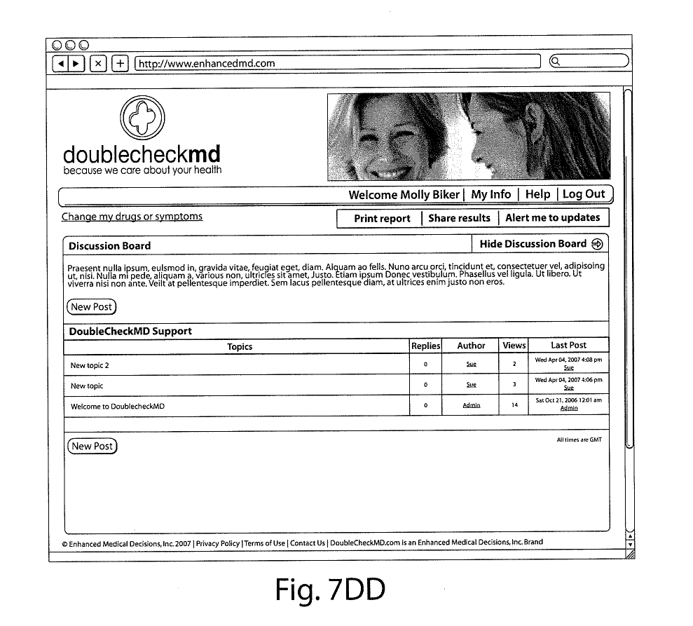

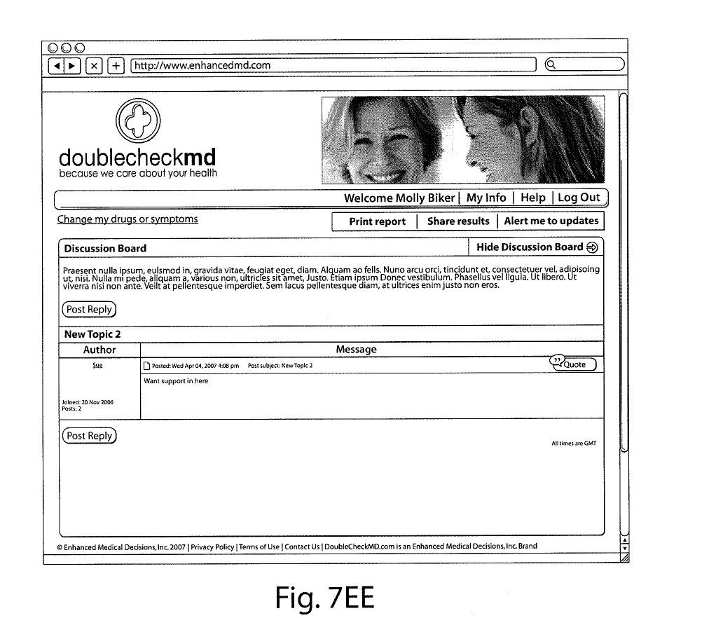

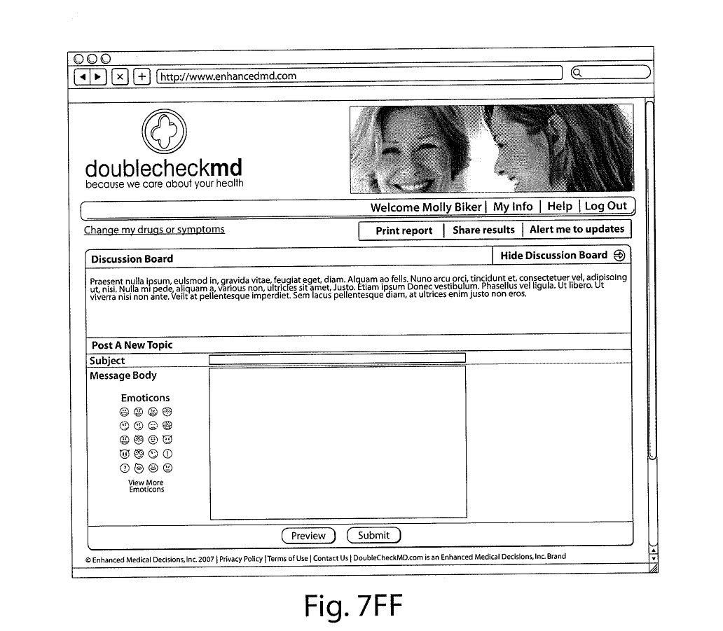

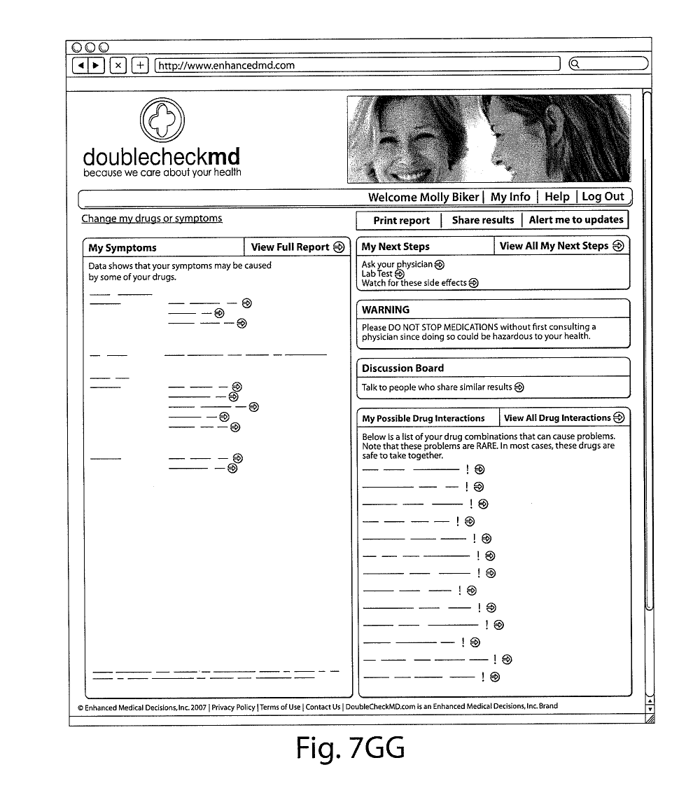

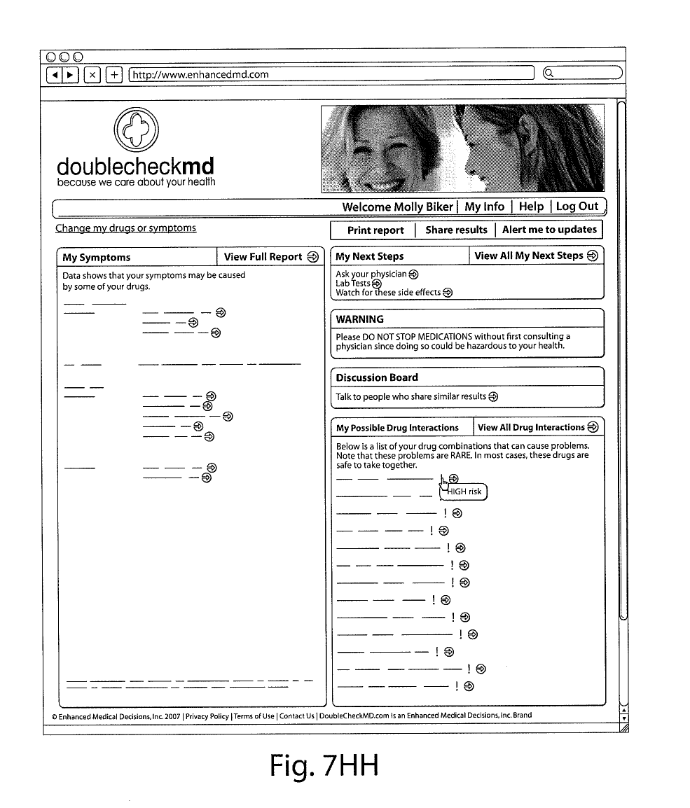

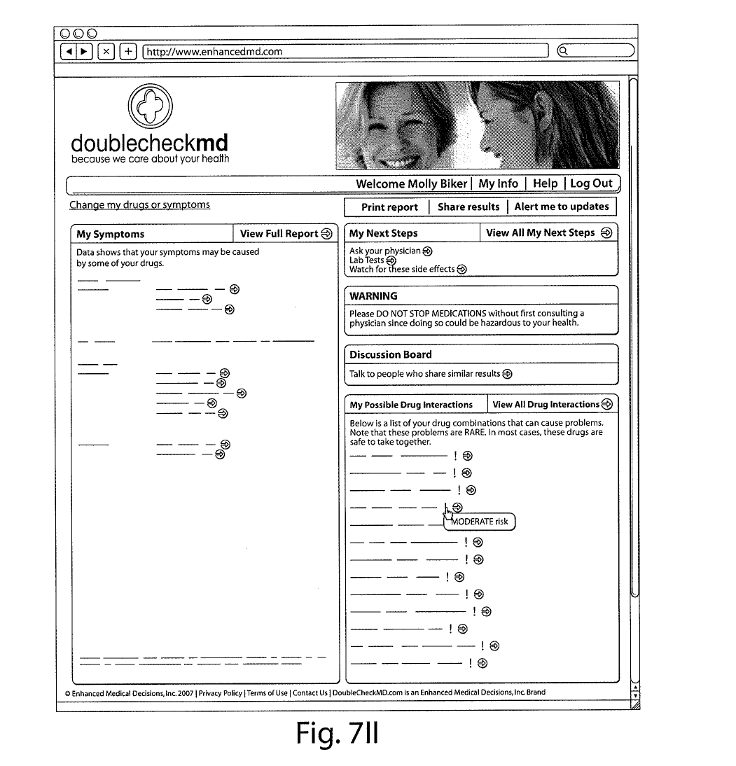

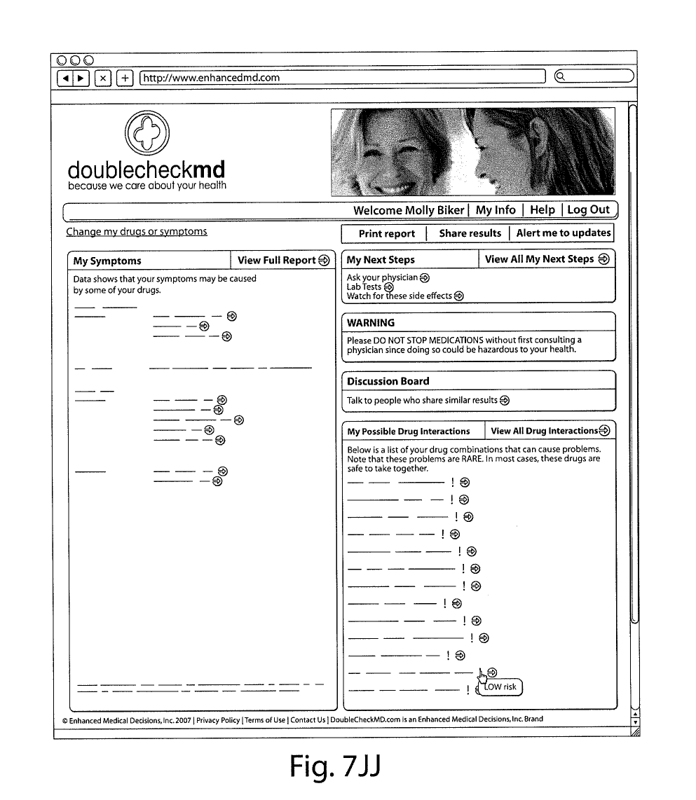

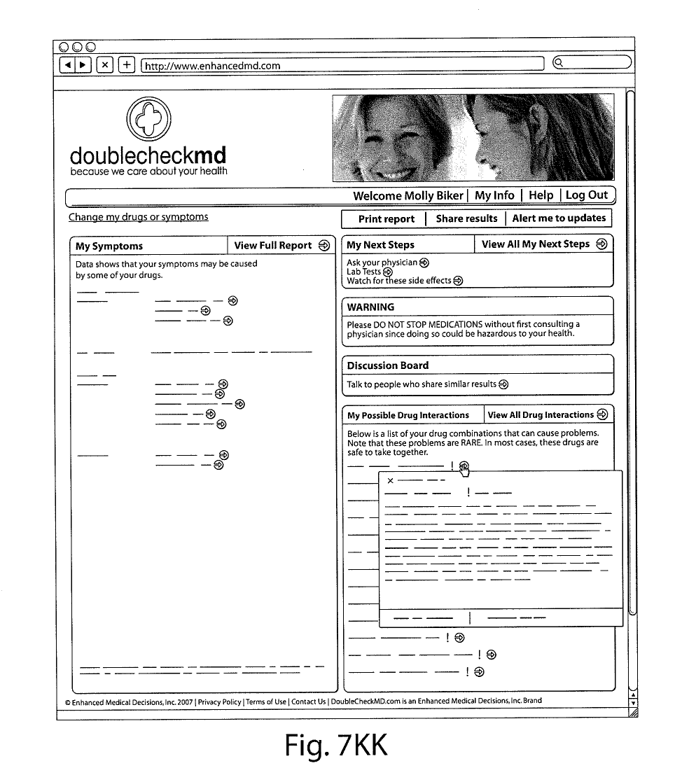

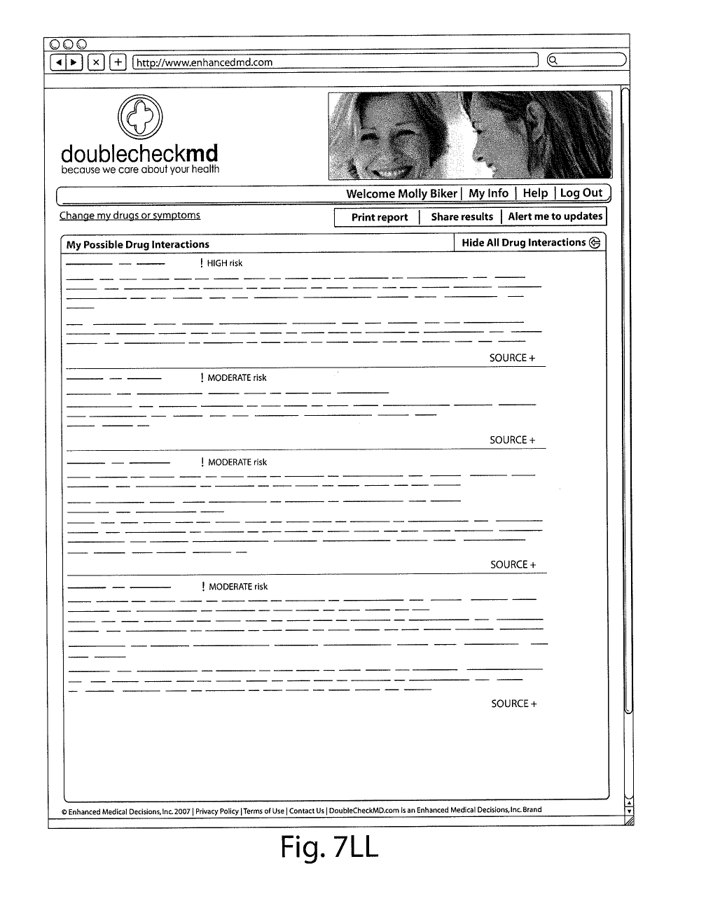

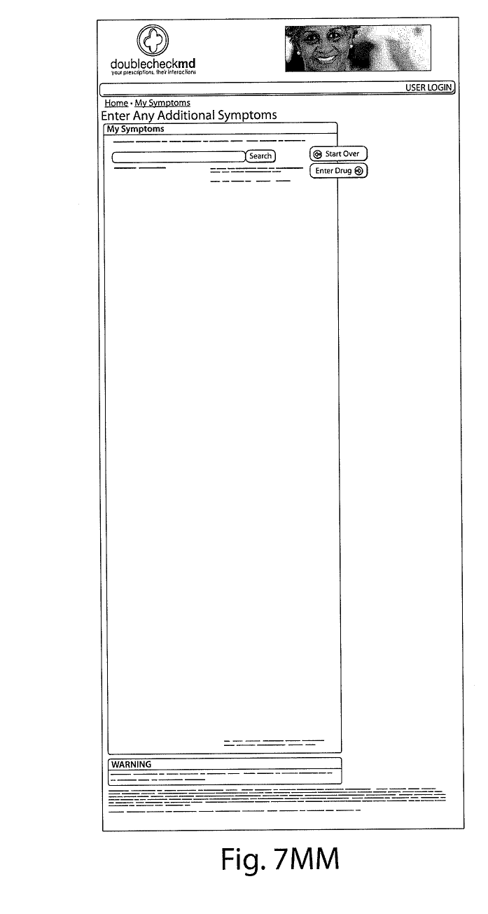

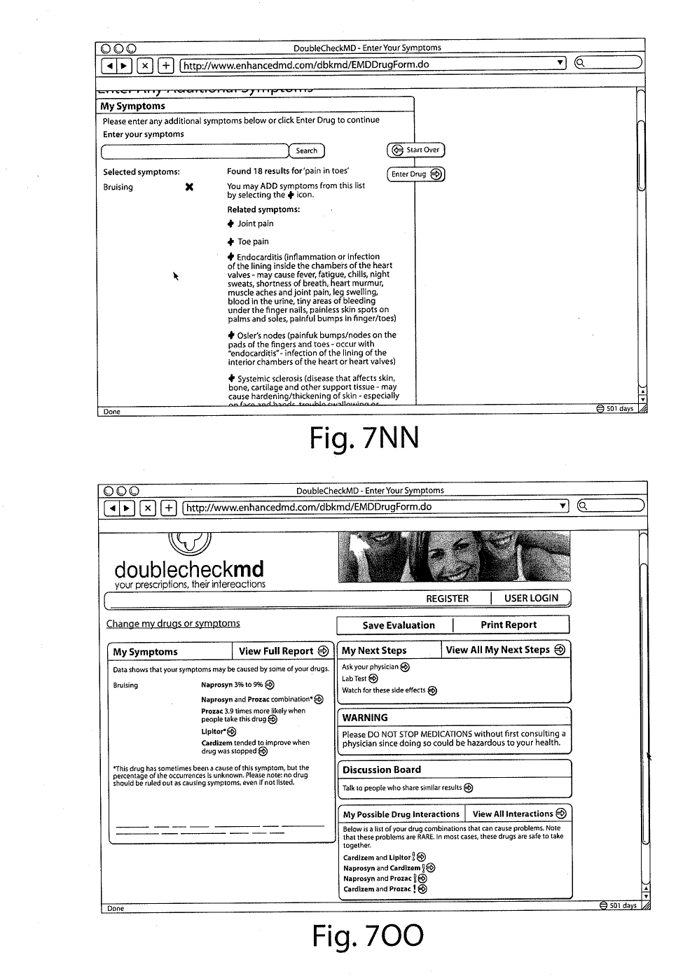

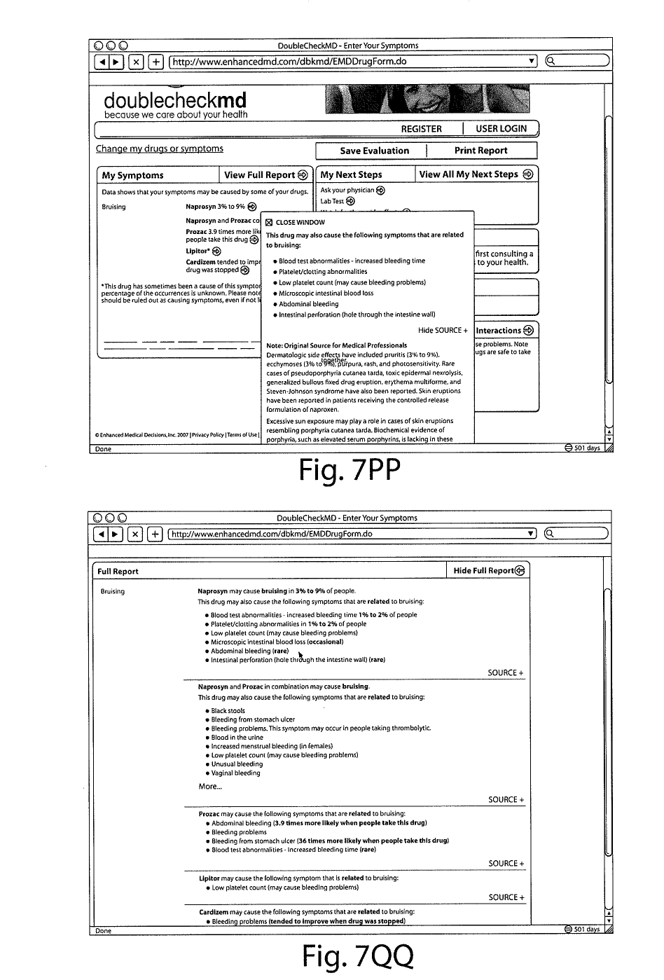

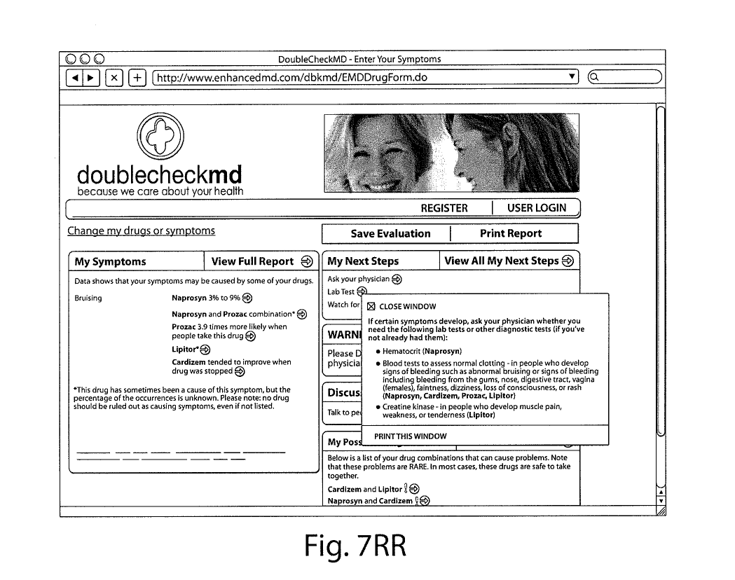

Referring to FIG. 6A, a flowchart of an exemplary procedure knowledge-based searching procedure 500 is shown. The knowledge based searched may be a medical knowledge base that can determine relationships between drugs taken by a patient and a host of symptoms experienced by the patient (e.g., to determine if there may be drug interaction between the various drugs taken). Initially, a search string is received 510 from a user providing the search string, e.g., via a user interface such as the one shown in FIGS. 7A-RR. The search string may be provided as a natural language query. Subsequently, multi-stage NL processing, which may be similar to the processing described above in relation to FIGS. 3-5 is applied 520 to the search string. Thus, the NL processing is performed using, for example, a dynamically generated set of concepts relating to one or more subject matters and relationships between at least some of the concepts. The NL processing performed on the search string generates a resultant search string determined based on the association of the search string with one or more of the concepts. Having performed NL processing on the search string to determine the meaning of the query provided by the user, the records of a database (e.g., a database previously populated using NL processing applied to data sources) are searched 530 based on the resultant search string. In some embodiments, the search string includes information relating to, for example, one or more medical drugs taken by a patient and/or one or more medical symptoms experienced by the patient. Under those circumstances, searching the database records may include determining, based on the information in the database records, relationships between the one or more medical drugs taken by the patient and the one or more medical symptoms experienced by the patient.

Referring to FIG. 6B, an exemplary output generated in response to a query provided by a user searching a medical knowledge-based system to determine possible drug interactions is shown. The user would, in some embodiments, be directed to a window-based user interface, and would provide symptoms the user (or someone else) is suffering from at the appropriate area in the user-interface (e.g., at an input field labeled “My Symptoms”). For example, the user may type “hazy thinking”. The user may be prompted to select possible alternative descriptions proposed by the system. For example, in response to “hazy thinking”, the system may propose “Decreased mental clarity” as an alternate option.

Subsequently, the user may enter at appropriate area on the drug-entry screen of the user-interface, any drugs the user may be taking. Thus, in the above example, the user may type “Lipitor” in a box labeled, for example, “My Drugs”. The user may then initiate processing (e.g., knowledge-based searching) by, for example, selecting an “Evaluate” icon presented on the user-interface. The processing performed by the system may thus result in an output page, displayed on the user-interface, that may be similar to the output shown in FIG. 6B.

FIGS. 7A-RR are screen shots of an exemplary user interface used in conjunction with the DoubleCheckMD Drugs application described herein. Specifically, and with reference to FIG. 7A, the end-user Product interface for the DoubleCheckMD Drugs application is shown. The end-user (e.g., patient, physician) enters the problem/symptom(s) in the center box in the page using natural language. For example, a patient end-user might type in “I have a pain in both shoulders and had a very bad headache 3 weeks ago”. The KEEP NLP engine processes this text fragment and codifies the Simple and Compound Concepts within the text and offers to the end-user a selection of structured concepts from its ontology that have been identified, from which the end-user can select any number of terms/phrases (see, for example, FIG. 7C). The system first displays concepts for which all of the constraints of at least one of the rules have been satisfied. Another list of partial matches is also offered to the end-user in a second list (see, for example, FIG. 7H) with lower-level matches located further down in the list in descending order according to goodness-of-fit. End-user can choose as many of these matches as they want in accordance with their best judgment of which matches best describe their individual situation. For example, a high-level match displayed to the end-user in the above example might include: “Polymyalgia rheumatica—a condition that can cause pain in larger joints such as shoulders, hips, ankles, and wrists; generally on both sides of the body; can also cause headache located in the temple area, inflammation of the arteries/blood vessel that can lead to loss of vision or blindness”.

Once the matches/partial matches have been selected, the DoubleCheckMD Drugs application requires that the end-user enter his/her medications (see FIGS. 7I, 7O, 7J). After a disclaimer has been accepted, the end-user receives the output data/information that is organized into a summary (“Evaluation”) page that is used to navigate through the information using a drill-down interface (see FIGS. 7N and 7Y). The output that appears in the Evaluation page is determined according to the following process.

First, the KEEP NLP processor saves the Basic Concepts that have been selected by the end-user into the database. The engine also saves in the database Basic Concepts that partially match the end-user selections. The engine then runs this data against the application's processed medical literature data sources that have been tagged, instantiated and classified. The DoubleCheckMD Drugs application then determines whether a particular drug or drug combination could be related to the selected symptom if the tagged medical information (complete or partial matches) matches the end-user selection (complete and partial matches).

In addition to displaying possible causes of symptom/problem, the DoubleCheckMD Drugs application attaches Modifier information for each Concept displayed in the end-user Evaluation page. For example, modifiers (identified by the NLP processor) may include the frequency with which a given symptom is caused by a drug/drug combination, the dose at which it is likely to occur, how long it typically lasts, whether it abates over time, etc. (see, for example, FIG. 7AA).

Other categories of information are displayed in the “Next Steps” section of the Evaluation page (for example, information about which tests, blood tests, or diagnostic procedures may be recommended when selected problems occur while taking specific medications. This database information is displayed if the following constraints are met: the user selects a symptom/problem (Basic Concept) that matches or partially matches a Basic Concept in the tagged source medical text of a drug or drug combination that he/she is taking, and a Knowledge Representation Rule from within the appropriate category (in this case, blood test or diagnostic procedure) is instantiated (the rule must include constraints that list the end-users drugs and symptom).

In addition, the Evaluation pages display translated information (i.e., translations of the original source text from technical medical to common language that is linked to instantiated Knowledge Representation nodes). The display of this information is triggered when a combination of a concept from a specified group of Basic Concepts (in these cases drugs) and a node from a specified group of Knowledge Representation nodes are triggered (in this case drug interaction involving selected drugs) are selected/instantiated.

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

What is claimed is:

1. A method to perform natural language (NL) processing, the method comprising:
accessing a data source having one or more data portions; and
applying multi-stage NL processing on the one or more data portions, using a dynamically generated set of concepts relating to one or more subject matters and relationships between at least some of the concepts, to determine the association of the one or more data portions with one or more of the concepts.

2. The method of claim 1 wherein applying the multi-stage NL processing comprises:
applying at least one stage of the multi-stage NL processing on intermediary one or more data portions resulting from processing performed by another stage of the multi-stage NL processing on the one or more data portions or a processed derivative of the one or more data portions.

3. The method of claim 1 wherein the set of the concepts and the relationships between the at least some of the concepts comprises an ontology organizing the concepts and the relationships.

4. The method of claim 1 further comprising:
modifying the dynamically generated set of the concepts and the relationships between the at least some of the concepts based on the processed one or more data portions.

5. The method of claim 4 wherein modifying the dynamically generated set comprises one or more of: adding at least one additional concept to the set, deleting at least one concept from the set, adding at least one additional relationship to the set and deleting at least one relationship from the set.

6. The method of claim 1 wherein the set of the concepts and the relationships between the at least some of the concepts comprises:
at least one complex concept associating two or more of the concepts.

7. The method of claim 1 wherein applying the multi-stage NL processing on the one or more data portions comprises:
applying at least one placement rule defining a contextual constraint on the one or more data portions to determine whether two or more terms in the one or more data portions are semantically related.

8. The method of claim 7 wherein applying the at least one placement rule comprises:
determining the whether the two or more terms in the one or more data portions are eligible for additional NL processing based on one or more of: semantic content of the one or more data portions, morphological content of the one or more data portions and syntactical content of the one or more data portions.

9. The method of claim 7 wherein applying at least one placement rule comprises:
applying a cascade of placement rules defining contextual constraints on the one or more data portions such that one of the cascade of rules is applied to the output resulting from a preceding one of the cascade of rules.

10. The method of claim 1 wherein the dynamically generated set of concepts relating to the one or more subject matters and relationships between the at least some of the concepts comprises:
a dynamically generated set of concepts relating to one or more subject matters of: medical applications, industrial applications, business applications, consumer applications and entertainment applications.

11. The method of claim 1 further comprising
adding information related to the identified one or more data portions to database records in a knowledge-based system, the database records corresponding to the identified one or more data portions.

12. The method of claim 11 wherein the information related to the identified one or more data portions includes one or more of: the identified one or more data portions and attributes of the respective identified at least some of the one or more data portions.

13. The method of claim 12 wherein the concepts relate to medical concepts and wherein a model is used to treat semantic and syntactic constraints within highly detailed rules as if they are interdependent rather than independent.

14. The method of claim 13 wherein the concepts include one or more of: one or more medical drug names, one or more medical conditions, one or more medical symptoms and one or more treatments.

15. The method of claim 11 further comprising:
receiving a search string;
determining a resultant search string based on performing another natural language processing operation on the received search string; and
searching the database records based on the resultant search string.

16. The method of claim 15 wherein the search string includes information relating to one or more of: one or more medical drugs taken by a patient and one or more medical symptoms experienced by the patient.

17. The method of claim 16 wherein searching the database records comprises determining, based on the information in the database records, relationships between the one or more medical drugs taken by the patient and the one or more medical symptoms experienced by the patient.

18. The method of claim 17 wherein the relationships between the one or more medical drugs taken by the patient and the one or more medical symptoms experienced by the patient includes information representative of whether the one or more medical drugs taken by the patient causes the one or more medical symptoms experienced by the patient.

19. The method of claim 17 further comprising presenting on a user interface output including the determined relationships between the one or more medical drugs taken by the patient and the one or more medical symptoms experienced by the patient.

20. The method of claim 1 wherein applying the multi-stage NL processing comprises:
performing language normalization to identify words within the one or more data portions matching entries of a pre-defined lexicon.

21. The method of claim 20 wherein performing language normalization comprises:
performing one or more of: sentence boundary parsing, word segmentation, lemmatization, stemming and identification of lexical variants including synonyms, acronyms, abbreviations, inflectional variants and derivational variants.

22. The method of claim 1 wherein applying the multi-stage NL processing comprises:
identifying for at least one part of the one or more data portions related concepts from the one or more concepts.

23. The method of claim 22 wherein identifying related concepts comprises:
performing concept identification for at least one of the one or more data portions on which language normalization was performed to identify words within the one or more data portions matching entries of a pre-defined lexicon.

24. The method of claim 22 wherein identifying related concepts comprises:
applying to the one or more data portions rules specifying semantic constraints and forward-chaining logic rules.

25. The method of claim 1 wherein applying the multi-stage NL processing comprises:
determining if two or more of the one or more data portions are semantically linked.

26. The method of claim 1 wherein applying the multi-stage NL processing is performed without performing statistical computations to determine semantic content.

27. A computer program product residing on a computer readable medium for natural language (NL) processing, the computer program product comprising instructions to cause a computer to:
access a data source having one or more data portions; and
apply multi-stage NL processing on the one or more data portions, using a dynamically generated set of concepts relating to one or more subject matters and relationships between at least some of the concepts, to determine the association of the one or more data portions with one or more of the concepts.

28. The computer program product of claim 27 further comprising instructions to cause the computer to:
modify the dynamically generated set of the concepts and the relationships between the at least some of the concepts based on the processed one or more data portions.

29. The computer program product of claim 27 wherein the set of the concepts and the relationships between the at least some of the concepts comprises:
at least one complex concept associating two or more of the concepts.

30. The computer program product of claim 27 wherein the instructions that cause the computer to apply the multi-stage NL processing on the one or more data portions comprise instructions that cause the computer to:
apply at least one placement rule defining a contextual constraint on the one or more data portions to determine whether two or more terms in the one or more data portions are semantically related.

31. The computer program product of claim 27 further comprising instructions to cause the computer to:
add information related to the identified one or more data portions to database records in a knowledge-based system, the database records corresponding to the identified one or more data portions.

32. The computer program product of claim 31 further comprising instructions to cause the computer to:
receive a search string;
determine a resultant search string based on performing another natural language processing operation on the received search string; and
search the database records based on the resultant search string.

33. The computer program product of claim 32 wherein the search string includes information relating to one or more of: one or more medical drugs taken by a patient and one or more medical symptoms experienced by the patient.

34. The computer program product of claim 33 wherein the instructions that cause the computer to search the database records comprises instructions that cause the computer to:
determine, based on the information in the database records, relationships between the one or more medical drugs taken by the patient and the one or more medical symptoms experienced by the patient.

35. An apparatus, comprising:
a computer system including a processor and memory; and
a computer readable medium storing instructions for natural language (NL) processing including instructions to cause the computer system to:
access a data source having one or more data portions; and
apply multi-stage NL processing on the one or more data portions, using a dynamically generated set of concepts relating to one or more subject matters and relationships between at least some of the concepts, to determine the association of the one or more data portions with one or more of the concepts.

36. The apparatus of claim 35 wherein the computer readable medium further comprises instructions to cause the computer system to:
modify the dynamically generated set of the concepts and the relationships between the at least some of the concepts based on the processed one or more data portions.

37. The apparatus of claim 35 wherein the set of the concepts and the relationships between the at least some of the concepts comprises:
at least one complex concept associating two or more of the concepts.

38. The apparatus of claim 35 wherein the computer readable medium comprising the instructions to cause the computer system to apply the multi-stage NL processing on the one or more data portions comprises instructions that cause the computer system to:
apply at least one placement rule defining a contextual constraint on the one or more data portions to determine whether two or more terms in the one or more data portions are semantically related.

39. The apparatus of claim 35 wherein the computer readable medium further comprises instructions to cause the computer system to:
add information related to the identified one or more data portions to database records in a knowledge-based system, the database records corresponding to the identified one or more data portions.

40. The apparatus of claim 39 wherein the computer readable medium further comprises instructions to cause the computer system to:
receive a search string;
determine a resultant search string based on performing another natural language processing operation on the received search string; and
search the database records based on the resultant search string.

41. The apparatus of claim 40 wherein the search string includes information relating to one or more of: one or more medical drugs taken by a patient and one or more medical symptoms experienced by the patient.

42. The apparatus of claim 41 wherein the computer readable medium comprising the instructions to cause the computer system to search the database records comprises instructions that cause the computer system to:
determine, based on the information in the database records, relationships between the one or more medical drugs taken by the patient and the one or more medical symptoms experienced by the patient.

43. A method for searching data, the method comprising:
receiving a search string;
applying multi-stage NL processing on the search string, using a dynamically generated set of concepts relating to one or more subject matters and relationships between at least some of the concepts, to generate a resultant search string determined based on the association of the search string with one or more of the concepts; and
searching records of a database based on the resultant search string.

44. The method of claim 43 wherein searching the records of the database comprises:
searching the records of a database populated with data generated by applying multi-stage NL processing on one or more data portions accessed from a data source, using the dynamically generated set of the concepts relating to the one or more subject matters and the relationships between at least some of the concepts, to determine the association of the one or more data portions with one or more of the concepts.

45. The method of claim 44 further comprising:
modifying the dynamically generated set of the concepts and the relationships between the at least some of the concepts based on one or more of: the processed one or more data portions and the search string.

46. The method of claim 43 wherein the search string includes information relating to one or more of: one or more medical drugs taken by a patient and one or more medical symptoms experienced by the patient.

47. The method of claim 46 wherein searching the database records comprises:
determining, based on the information in the database records, relationships between the one or more medical drugs taken by the patient and the one or more medical symptoms experienced by the patient.

48. The method of claim 24 wherein the data portion rules are based on Syntactical Rule Model (SRM) rules having a pre-defined part-of-speech/concept configuration.

49. The method of claim 1 wherein applying the multi-stage NL processing comprises:
applying disambiguation rules.
